(19) United States
(12) Patent Application Publication
(10) Pub. No.: US 2019/0059418 A1
(43) Pub. Date: Feb. 28, 2019

(54) Integrated Infusion, Extraction, and Acid Removal Process

(71) Applicant: Ocean Spray Cranberries, Inc., Lakeville-Middleboro, MA (US)

(72) Inventors: Michael DiMarzio, Lakeville-Middleboro, MA (US); Erich Fritz, Lakeville-Middleboro, MA (US); Raghunandan Kandala, Lakeville-Middleboro, MA (US); Ryan Moriarty, Lakeville-Middleboro, MA (US); Stephen Nojeim, Lakeville-Middleboro, MA (US); Stephen Peabody, Lakeville-Middleboro, MA (US); Soumya Roy, Lakeville-Middleboro, MA (US); Kirk Willard, Lakeville-Middleboro, MA (US)

(21) Appl. No.: 16/120,117

(22) Filed: Aug. 31, 2018

Related U.S. Application Data
(60) Provisional application No. 62/553,079, filed on Aug. 31, 2017.
(60) Provisional application No. 62/553,029, filed on Aug. 31, 2017.
(60) Provisional application No. 62/552,996, filed on Aug. 31, 2017.

(51) Int. Cl. A23L 2/08; A23L 2/68

(52) U.S. Cl. CPC A23L 2/087; A23L 2/74; A23V 2300/10; A23L 2/68

(57) ABSTRACT

A method of processing a fruit or vegetable is described. The method includes contacting a fruit or vegetable in an optimizer with a first deacidified juice, the first deacidified juice including at least one bulking agent and a sugar concentration that is at least about equal to the sugar concentration in the fruit or vegetable, under conditions sufficient to transfer acids from the fruit or vegetable to the first deacidified juice and bulking agent from the first deacidified juice to the fruit or vegetable, thereby producing an acidified juice and an infused fruit or vegetable product. The method also includes removing acids from the acidified juice to produce a second deacidified juice, mixing the second deacidified juice with at least one bulking agent, and, optionally, recycling the second deacidified juice comprising at least one bulking agent to the optimizer.

### CROSS REFERENCE TO RELATED APPLICATIONS

This application claims priority to U.S. Application No. 62/553,079, filed on Aug. 31, 2017, U.S. Application No. 62/553,029, filed on Aug. 31, 2017, and U.S. Application No. 62/552,996, filed on Aug. 31, 2017, the contents of which are hereby incorporated by reference in their entirety.

### TECHNICAL FIELD

The present disclosure provides fruit and vegetable products and methods of making the fruit and vegetable products.

### BACKGROUND

Dried fruits and vegetables have gained popularity as a nutritious product. Cranberries, in particular, are naturally low in sugar and high in acids. Unless more sugar is added, the low sugar to acid ratio results in a tart taste, which is intensified when the cranberries are dried. Therefore, dried cranberries are generally infused with sweeteners, typically sucrose, to make the dried cranberries palatable.

### SUMMARY

The present disclosure is based, in part, on the discovery of new continuous and non-continuous processes for producing a fruit or vegetable product with ingredients derived from the fruit or vegetable. The present disclosure is also based, in part, on the discovery of new methods for naturally increasing the sugar to acid ratio of a fruit or vegetable. Processes described herein are useful, e.g., for acid removal, bulking agent and nutrient addition, and maintenance of sugar and acid levels within the fruit or vegetable simultaneously.

The present disclosure also provides a description of an infused fruit or vegetable with a naturally increased sugar to acid ratio, phenolics to acid ratio, and/or phenolics to quinic acid ratio. The systems and methods described herein may offer the advantage that a concurrent extraction and infusion limits damage to the fruit being extracted and infused as compared to traditional methods. The systems and methods described herein may offer the advantage that many components of the fruit are used to produce a composition where all components are derived from the process and obtained from fruit. The compositions may offer the advantage of being low in sugars while having a desirable taste (e.g., are not too tart).

In one aspect, the present specification provides a method of processing a fruit or vegetable. The method can include providing a fruit or vegetable, or multiple types of fruit or multiple types of vegetables, or fruit and vegetable mixtures, in an optimizer (e.g., a countercurrent exchange device). The method can include contacting a fruit or vegetable in an optimizer with a first deacidified juice that includes at least one bulking agent and that has a sugar concentration that is at least about equal to (or greater than) the sugar concentration in the fruit or vegetable in the optimizer, under conditions that allow a transfer of acids from the fruit or vegetable to the first deacidified juice, and transfer of the bulking agent from the first deacidified juice to the fruit or vegetable, thereby producing an acidified juice and an infused fruit or vegetable product; removing acids from the acidified juice to produce a second deacidified juice; and mixing the second deacidified juice with at least one bulking agent. Optionally, the second deacidified juice comprising the bulking agent can be recycled back to the optimizer, e.g., for one or more rounds of contacting of the fruit or vegetables (e.g., fruit or vegetable products) with the second deacidified juice in the optimizer, e.g., under conditions sufficient to transfer acids from the fruit or vegetable to the second deacidified juice, and to transfer bulking agent from the second deacidified juice to the fruit or vegetable. The fruit or vegetable in the optimizer can be a sliced, scarified, pitted, and/or pierced fruit or vegetable. The first deacidified juice can include juice derived from the same type of fruit or vegetable as that in the optimizer, or juice derived from a fruit or vegetable that is of a type different from that in the optimizer, or a mixture thereof. In some instances, the fruit or vegetable in the optimizer is a fruit, such as a cranberry, grape, blueberry, raspberry, elderberry, lingonberry, chokeberry, blackberry, blackcurrant, redcurrant, white currant, huckleberry, cloudberry, or strawberry, or a mixture of any two or more of different types of fruit. In some instances, the fruit or vegetable is a cranberry.

In some instances, the acidified juice comprises proanthocyanidins and phenolics removed from the fruit or vegetable in the optimizer, and a method can include removing proanthocyanidins and phenolics from the acidified juice via ultrafiltration before removing acids from the acidified juice. In some instances, the methods can include mixing the proanthocyanidins and phenolics removed from the acidified juice with the second deacidified juice.

In some instances, the method can include removing acids from the acidified juice, such as removing malic acid or citric acid, or both from the acidified juice, and/or removing quinic acid from the acidified juice. In some instances, removing acids from the acidified juice can include first removing malic and citric acids from the acidified juice by contacting the acidified juice with a first anion exchange resin and subsequently removing quinic acid from the acidified juice by contacting the acidified juice with a second anion exchange resin. Such methods can include regenerating the first anion exchange resin and the second anion exchange resin with at least one of a phosphoric acid rinse or a deionized water rinse, e.g., prior to and/or following use of the exchange resins to remove acids. In some instances, removing acids from the acidified juice comprises treating the acidified juice in a bipolar electrodialysis unit, or a combination of contacting the acidified juice with anion exchange resins and treating the acidified juice in a bipolar electrodialysis unit.

In some instances, the optimizer is a countercurrent exchange device, and in such instances, the fruit or vegetable can be fed into the device at a bottom portion of the countercurrent exchange device and the first or second deacidified juice, or both, can be fed at the top of the countercurrent exchange device.

In some instances, the bulking agent can include at least one of glucose, fructose, maltodextrin, inulin, soluble fiber, or protein, or any mixtures thereof. In some instances, the bulking agent can comprise bulking agent derived from the same or different type of fruit or vegetable as that present in the optimizer.

In some instances, the method can further include removing the infused fruit or vegetable product from the optimizer and drying the infused fruit or vegetable product. In another aspect, the present specification provides a dried fruit or vegetable product produced by such methods described above.

In another aspect, the specification provides a system comprising: an optimizer configured to cause an exchange of acids and/or sugars between a fruit or vegetable and an extraction/infusion liquid (such as a countercurrent exchange device or tank); an ultrafiltration device in fluid communication with the optimizer and configured to remove proanthocyanidins and phenolics from a liquid; a deacidification subsystem in fluid communication with the ultrafiltration device and configured to remove acids from a liquid; and a mixing subsystem in fluid communication with both the deacidification subsystem and the optimizer, and configured to mix a deacidified juice and a bulking agent. In some instance, the system can include a device for scarifying, pricking, slicing, or pitting the fruit or vegetable. In some instances, the optimizer can be a module including two or more single- or multi-functional separate devices, each device being connected by lines. In some instances, the optimizer includes a tank, a countercurrrent infusion device, a countercurrent extraction device, or any combination thereof. In some instances, the optimizer can include multiple modules.

In some instances, the deacidification subsystem can include a bed of a first anion exchange resin configured to remove malic and citric acids from a liquid and a bed of a second anion-exchange resin configured to remove quinic acid from a liquid. In some instances, the deacidification subsystem can include a bipolar electrodialysis unit.

In some instances, the mixing subsystem can include at least one blend tank and at least one hold tank.

In still another aspect, the specification provides a method, comprising: contacting (e.g., in a countercurrent exchange device) a fruit or vegetable with a first deacidified juice comprising a sugar concentration at least about equal to that in the fruit or vegetable, under conditions that allow relatively concurrent removal of acids from the fruit or vegetable and of at least maintenance, or in some instances increasing, the sugar level in the fruit or vegetable, to thereby produce an acidified juice and a reduced-acid fruit or vegetable product.

In some instances, the method further includes removing acids from the acidified juice to produce a second deacidified juice. Removing acids from the acidified juice can include, e.g., removing malic and citric acids in a first anion exchange process and removing quinic acid in a second anion exchange process.

In some instances, the fruit or vegetable is a fruit, and the fruit is a cranberry, grape, blueberry, raspberry, elderberry, lingonberry, chokeberry, blackberry, blackcurrant, redcurrant, white currant, huckleberry, cloudberry, or strawberry, or a mixture of any two or more of different types of fruit. In some instances, the fruit is a cranberry.

In some instances, the acidified juice can further include proanthocyanidins and phenolics removed from the fruit. In some instances, the method can further include removing proanthocyanidins and phenolics from the acidified juice via ultrafiltration.

In some instances, the first deacidified juice can include at least one bulking agent selected from the group consisting of glucose, fructose, maltodextrin, inulin, and soluble fiber. In some instances, the first deacidified juice can include juice derived from the same or different type of fruit or vegetable as that being contacted with the first deacidified juice. In some instances, the first deacidified juice comprises juice derived from cranberries.

In some instances, contacting comprises contacting using countercurrent exchange, e.g., in a countercurrent exchange device. In such instances, the fruit or vegetable may be provided at a bottom portion of a countercurrent exchange device and the deacidified juice may be fed into the device at a top of the countercurrent exchange device.

In some instances, the concentrations of fructose and glucose in the first deacidified juice is greater than or equal to the concentrations of fructose and glucose in the fruit or vegetable. In some instances, the dissolved solids content of the acidified juice is approximately 1% to 65% wt. In some instances, the first deacidified juice has a pH of approximately 3.5 to 6.0.

In yet another aspect, the specification provides a method of purifying an acid from a fruit juice. Such methods can include, e.g., contacting the fruit juice with a first anion exchange resin, wherein the first anion exchange resin is configured to adsorb malic acid and citric acid from the fruit juice, thereby producing a partially deacidified fruit juice; contacting the partially deacidified fruit juice with a second anion exchange resin, wherein the second anion exchange resin is configured to adsorb quinic acid from the partially deacidified fruit juice, thereby producing a deacidified fruit juice and quinic acid adsorbed to the second anion exchange resin; eluting, from the second anion exchange resin, a quinic acid rich solution comprising quinic acid and salts; and contacting the quinic acid rich solution with a strong acid cation exchange resin, thereby separating the quinic acid rich solution into an acid solution and a salt solution. In some instances, at least one of the first anion exchange resin, the second anion exchange resin, and the strong acid cation exchange resin, is disposed in a bed. In some instances, at least one of the first anion exchange resin and the second anion exchange resin is a macroporous polystyrene based resin comprising divinyl benzene co-polymers.

In some instances, the method can further include crystallizing the quinic acid. Crystallizing the quinic acid can include, e.g., concentrating the quinic acid solution under vacuum to a concentration of greater than 45% m/m, seeding the solution with 1% dry weight basis of purified quinic acid, and cooling the solution to 1° C.

In some instances, the fruit juice is cranberry juice. The fruit juice may have, e.g., a dissolved solids content of about 1% to about 70% wt, e.g., a dissolved solids content of about 1% to about 25% wt., or e.g., a dissolved solids content of about 16% to about 20% wt.

In some instances, eluting the quinic acid comprises rinsing the second anion exchange resin with a minimum 0.253 N basic solution. In some instances, the method further includes regenerating the strong acid cation exchange resin with hydrochloric acid.

In still another aspect, the specification provides a method of deacidifying a fruit juice. Such methods can include, e.g., contacting the fruit juice with a first anion exchange resin configured to adsorb malic acid and citric acid from the fruit juice, thereby producing a partially deacidified fruit juice; and contacting the partially deacidified fruit juice with a second anion exchange resin configured to adsorb quinic acid from the partially deacidifed fruit juice to thereby produce a deacidified fruit juice, wherein the second anion exchange resin has a higher affinity for quinic acid than the first anion exchange resin.

In some instances, the fruit juice is cranberry, grape, blueberry, raspberry, elderberry, lingonberry, chokeberry, blackberry, blackcurrant, redcurrant, white currant, huckleberry, cloudberry, or strawberry juice, or any mixture of any two or more of different types of fruit juice. In some instances, the fruit juice is cranberry juice. In some instances, the fruit juice can have a dissolved solids content of about 1% to about 70% wt, e.g., the fruit juice has a dissolved solids content of about 1% to about 25% wt., or e.g., the fruit juice has a dissolved solids content of about 16% to about 20% wt.

In some instances, the method further includes measuring at least one of acid content and pH based on a color of cranberry pigment.

In some instances, the methods further include eluting the malic acid and citric acid from the first anion exchange resin with a basic solution at a concentration of 0.1 to 1.0 N. In some instances, the methods further include regenerating the first anion exchange resin with a maximum 1.04 N basic solution.

In still another aspect, the specification provides a deacidified fruit juice produced by the methods described above.

In another aspect, the specification provides a method of producing an alcoholic beverage. Such methods can include, e.g., contacting a fruit juice with a first anion exchange resin configured to adsorb malic acid and citric acid from the fruit juice, thereby producing a partially deacidified fruit juice; contacting the partially deacidified fruit juice with a second anion exchange resin configured to remove quinic acid from the partially deacidified fruit juice to thereby produce a deacidified fruit juice, wherein the second anion exchange resin has a higher affinity for quinic acid than the first anion exchange resin; and fermenting the deacidified fruit juice.

In some instances, the method further comprises mixing, prior to fermenting, a volume of non-deacidified fruit juice with the deacidified fruit juice. In some instances, mixing can produce a fruit juice having a pH between 3.5 and 6.0. In some instances, the fruit juice is cranberry juice. In some instances, the fruit juice has a dissolved solids content of about 1% to about 65% wt., e.g., the fruit juice has a dissolved solids content of about 1% to about 25% wt., or e.g., the fruit juice has a dissolved solids content of about 16% to about 20% wt.

In another aspect, the specification provides an alcoholic beverage produced using any of the methods described above.

In yet another aspect, the specification provides a method of producing an alcoholic beverage. Such methods can include, e.g., contacting a fruit juice with a first anion exchange resin configured to adsorb malic acid and citric acid from the fruit juice to thereby produce a partially deacidified fruit juice; and fermenting the partially deacidified fruit juice. In some instances, the partially deacidified fruit juice can have a pH between 3.5 and 6.0.

In yet another aspect, the specification provides a method, e.g., a method of treating cellulosic biomass material derived from fruit. Such methods can include, e.g., forming a mixture of water and cellulosic biomass material derived from fruit, the cellulosic biomass material comprising insoluble solids; raising the temperature of the mixture to greater than or equal to 150° C. and the pressure of the mixture to greater than or equal to 50 psi, thereby converting insoluble solids in the cellulosic biomass material to soluble solids; and separating the soluble solids and water from remaining insoluble solids. In some instances, separating soluble solids can include separating the soluble solids from the remaining insoluble solids via centrifugation, filtration, or a combination of centrifugation and filtration. In some instances, the temperature can be raised to approximately 150-200° C. and the pressure can be raised to approximately 500-2500 psi. For example, the temperature can be raised to approximately 150-200° C. and the pressure can be raised to approximately 50-500 psi. In some instances, the method can further include pre-heating the mixture to approximately 50° C. to 99° C. In some instances, the soluble solids separated from the remaining insoluble solids can comprise at least a 40% yield of soluble solids from the cellulosic biomass material. In some instances, the soluble solids separated from the remaining insoluble solids can comprise at least a 60% yield of soluble solids from the cellulosic biomass material.

The method can further include washing the remaining insoluble solids to capture soluble solids trapped among the remaining insoluble solids. In some instances, the cellulosic biomass material is, e.g., presscake, pomace, or whole fruit, or mixtures thereof. In some instances, the presscake, pomace, or whole fruit can be derived from or comprise cranberries.

In some instances, the methods can further include converting at least some of the soluble solids into at least one of sugars, alcohols, and small chain fatty acids, or any combination thereof. Converting at least some of the soluble solids into sugars can include, e.g., digesting the soluble solids with enzymes. In some instances, the method can be performed as a batch process with a pressure cooker, an autoclave, or a subcritical water extraction unit, or any combination thereof. In some instances, the mixture is heated under pressure for approximately 3 to 10 minutes. In some instances, the method can further include cooling the mixture to a temperature of approximately 4° C. to 50° C.

In still another aspect, the specification provides a method of converting insoluble solids to soluble solids. Such methods can include, e.g., forming a mixture of water and cellulosic biomass material derived from fruit, the cellulosic biomass material comprising insoluble solids; passing the mixture of water and cellulosic biomass material through a direct steam injection system with a steam pressure of at least or about 125 psig and that heats the mixture to at least or about 150° C. with a back pressure of at least or about 55 psig; and separating the soluble solids and water from remaining insoluble solids.

Separating soluble solids can include, e.g., separating the soluble solids from the remaining insoluble solids via centrifugation, via filtration, or by a combination of centrifugation and filtration.

In some instances, the methods can further include pre-heating the mixture to approximately 50° C. to 99° C. In some instances, the soluble solids separated from the remaining insoluble solids comprise at least a 40% yield of soluble solids from the cellulosic biomass material, or e.g., at least a 60% yield of soluble solids from the cellulosic biomass material. In some instances, the method further includes washing the remaining insoluble solids to capture soluble solids trapped among the remaining insoluble solids.

The cellulosic biomass material can be, e.g., presscake, pomace, or whole fruit, or any combination thereof. In some instances, the presscake, pomace, or whole fruit derived from or comprising cranberries.

In some instances, the methods comprise converting at least some of the soluble solids into at least one of sugars, alcohols, and small chain fatty acids, or any combination thereof. Converting at least some of the soluble solids into sugars can include, e.g., digesting the soluble solids with enzymes.

In yet another aspect, the specification provides a method of treating a food body. Such methods can include, e.g., introducing the food body to a tank, the food body being suspended in a liquid medium and having a first temperature; introducing additional liquid medium to the tank, the additional liquid medium having a second temperature; mixing the liquid medium and the additional liquid medium in the tank at a low shear rate; and removing the food body from the tank, wherein the food body has a third temperature upon removal, wherein the first temperature is lower than the third temperature and the third temperature is lower than the second temperature, and wherein the third temperature is in the range of about 35° F. to about 70° F.

In some instances, the first temperature is in the range of about 10° F. to about 32° F. In some instances, the second temperature is in the range of about 60° F. to 120° F. In some instances, the food body has a residence time in the tank of approximately 2 minutes to 30 minutes.

In some instances, the tank comprises an impeller disposed on a shaft. The tank can have, e.g., an approximately circular footprint and the shaft and the impeller can be located off-center of the center of the approximately circular footprint.

In some instances, mixing the liquid medium and the additional liquid medium at a low shear rate comprises vertically circulating the liquid medium and the additional liquid medium in the tank. In some instances, the impeller has two inner lobes, each inner lobe connected on an opposite side of the shaft, and two outer lobes, each outer lobe connected to an inner lobe, wherein the inner lobes circulate the liquid medium in a first vertical direction and the outer lobes circulate the liquid medium in a second vertical direction.

In some instances, the food body is in a frozen state when the food body is at the first temperature and wherein the food body is in an unfrozen state at the third temperature.

In still another aspect, the specification provides a system comprising: a tank, comprising: a shaft disposed in the tank and extending from the bottom of the tank to the top of the tank, the shaft being configured to rotate; and a first impeller positioned on the shaft and configured to rotate with the shaft, the impeller having a shape configured to vertically circulate liquid media in the tank; a first inlet configured to deliver a food body suspended in liquid media at a first temperature to a tank; a second inlet configured to deliver additional liquid media at a second temperature to the tank; and an outlet configured to deliver a food body suspended in liquid media at a third temperature from the tank, wherein the first temperature is lower than the third temperature and the third temperature is lower than the second temperature, wherein the third temperature is in a range of about 35° F. to about 70° F. The first temperature can be, e.g., approximately 10° F. to 32° F. The second temperature can be, e.g., approximately 60° F. to 120° F. In some instances, the food body has a residence time in the tank of approximately 2 minutes to 30 minutes.

In some instances, the system can further include a separator connected to the outlet and configured to separate the food body from the liquid media at the third temperature. In some instances, the system can further include a heating element configured to heat the liquid media from the third temperature to the second temperature and further include a return configured to return the liquid media heated to the second temperature to the second inlet. In some instances, the tank has an approximately circular footprint and the shaft and the first impeller are located off-center of the center of the approximately circular footprint. In some instances, the separator can be, e.g., a shaker. In some instances, the first impeller can have two inner lobes, each inner lobe connected on an opposite side of the shaft, and two outer lobes, each outer lobe connected to an inner lobe, wherein the inner lobes circulate the liquid medium in a first vertical direction and the outer lobes circulate the liquid medium in a second vertical direction. In some instances, the inner lobes of the first impeller can have greater surface area than the outer lobes of the impeller. In some instances, the outer lobes of the first impeller can be angularly offset from the inner lobes of the impeller. In some instances, the food body is in a frozen state when the food body is at the first temperature and wherein the food body is in an unfrozen state at the third temperature. In some instances, the system further includes a second impeller disposed on the shaft. In some instances, the first impeller is positioned lower on the shaft than the second impeller.

In still another aspect, the specification provides an infused fruit or vegetable having a ratio of total acids to phenolics of less than 4:1, or a composition including such an infused fruit or vegetable (e.g., a confection, fruit bar, cereal, etc.). The infused fruit or vegetable can further include an infused bulking agent comprising at least one of glucose, fructose, sucrose, a sugar alcohol, maltodextrin, a dextrin, a glucan, a fructan, soluble fibers, amino acids, peptides, and partially hydrolyzed proteins of less than 10,000 Daltons, or any mixture thereof.

In some instances, the infused fruit or vegetable is an infused cranberry. The infused cranberry can include, e.g., glucose at approximately 4% by weight and fructose at approximately 1% by weight. The infused cranberry can include, e.g., a ratio of quinic acid to citric acid to malic acid between 1.0:1.0:0.8 and 10.0:1.0:2.0. The infused cranberry can include, e.g., nonpolar molecules having a carbon to oxygen ratio ranging from 18:2 to 28:2.

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

Other features and advantages of the invention will be apparent from the following detailed description and figures, and from the claims.

### DESCRIPTION OF DRAWINGS

FIG. 1A is a schematic of a system for producing a fruit or vegetable product.

FIG. 1B is a schematic of another system for producing a fruit or vegetable product.

FIG. 2 is a schematic of a countercurrent extraction unit that may be used as or as a part of an optimizer.

FIG. 3 is a schematic of a screw conveyor of a countercurrent extraction unit that includes paddles.

FIG. 4 is a schematic of a system for extracting and purifying organic acids from cranberry juice.

FIG. 5A is a schematic of a process of fermenting deacidified cranberry juice into alcohol.

FIG. 5B is a schematic of a process of fermenting deacidified cranberry juice with added cranberry concentrate into alcohol.

FIG. 6 is a chromatogram showing concentrations of stream components after running through a first column of the system of FIG. 4.

FIG. 7 is a chromatogram showing concentrations of stream components after running through a second column of the system of FIG. 4.

FIG. 8 is a chromatogram showing concentrations of stream components after running through a third column of the system of FIG. 4.

FIG. 9 is a schematic of a method for converting insoluble fibers to soluble fibers.

FIG. 10 is a graph depicting the percent of yield of soluble solids treated at different temperatures and pressures, along with the subsequent enzyme treatment of the biomass.

FIG. 11 is a graph depicting a ratio of sugars to soluble fibers produced by treatments at different temperatures and pressures.

FIG. 12 is a schematic of a system for producing a product using a defrosting step.

FIG. 13 is a cross-sectional view of a defrost tank used in the system of FIG. 12.

FIG. 14 is a top view of the defrost tank of FIG. 13.

FIG. 15A is a top view of an impeller disposed in the defrost tank of FIG. 13.

FIG. 15B is a side view of the impeller of FIG. 15A.

FIG. 16 is a photograph of the impeller of FIG. 15A annotated to show fluid flow around the impeller.

### DETAILED DESCRIPTION

This disclosure describes, e.g., processes for producing a fruit or vegetable product. The processes involve, e.g., increasing the sugar to acids ratio in the fruit or vegetable through a concurrent acid extraction and bulking agent infusion process. Traditional methods of increasing the sugar to acid content of the fruit or vegetable merely include adding additional sucrose. However, it is often not desirable to have high amounts of added sugar in a fruit or vegetable product. Using processes described herein can reduce the need to add sugar, or reduce the amount of sugar needed, to improve the taste of the product. The infused composition can be more finely adjusted allowing for specific ratios of single organic acids, sugars, and polyphenols. Advantageously, processes described herein can produce fruit or vegetable products where all of the ingredients are derived from the fruit or vegetable itself.

Furthermore, known processes of extraction and/or infusion may be damaging to berries or other fruit being extracted or infused. Damage done to fruit often leads to infused syrup leaking out of the finished dried fruit during storage, which is commonly termed as “syrup expression”. The processes disclosed herein are less damaging to fruit, which allows higher infusion with less syrup expression. The processes described herein allow for removal of acids from fruit with less removal of fruit sugars and phenolics by using concurrent extraction of acids and infusion of bulking agents. The invention also describes conversion of insoluble fibers, more specifically, insoluble fruit fibers to soluble fibers, so that extracted presscake material, rich in fibers and phenolics can in some instances be used as at least part of the bulking agent.

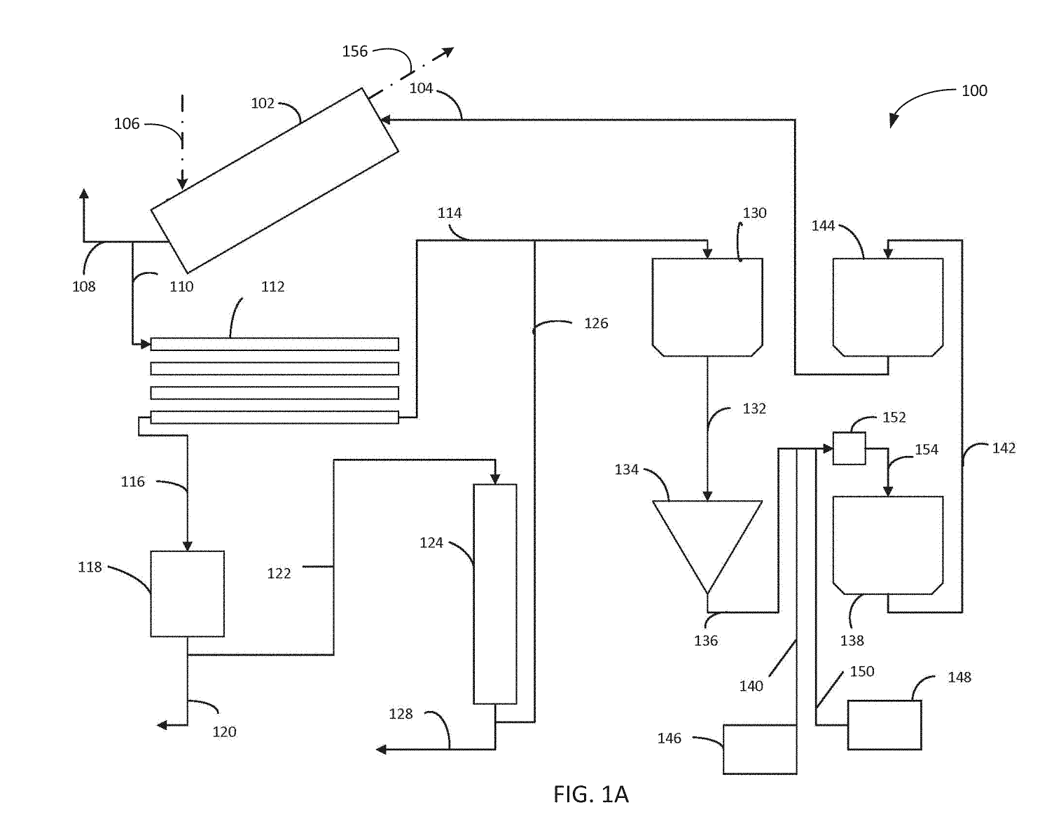

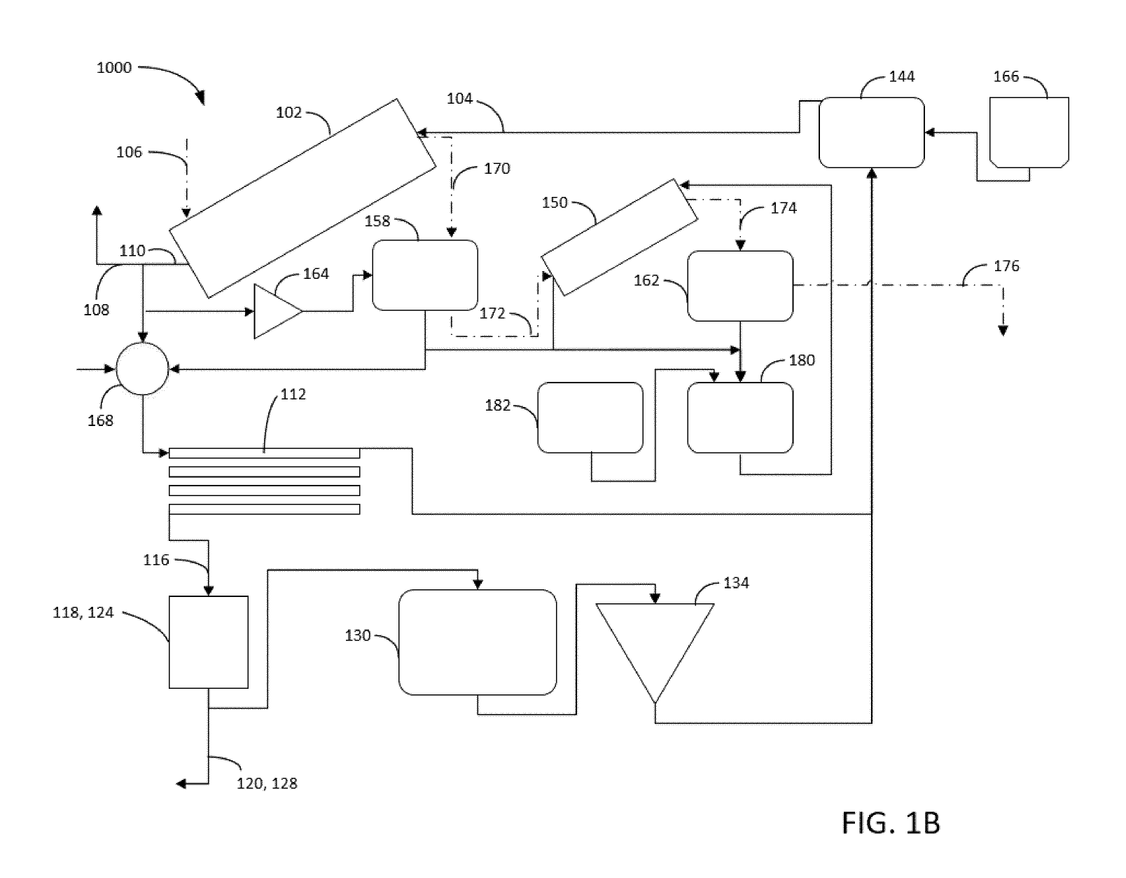

FIGS. 1A and 1B are schematics of continuous processes or systems 100 and 1000, respectively, for producing a dried fruit or vegetable product. In these exemplary processes, there are four main areas, or sub-processes: infusion and extraction, ultrafiltration, acid removal, and evaporation and mixing. Flow of syrup and other liquids are shown in solid lines and flow of the fruit is shown in dot-dash lines. The sub-processes are described in detail below before turning to an overall description of exemplary systems 100 and 1000, shown in FIGS. 1A and 1B, respectively.

Exemplary systems 100 and 1000 will be described in relation to producing a cranberry product. However, skilled practitioners will immediately appreciate that other fruits and vegetables may be used, and that other configurations of the system and/or order of process steps are possible. Such variations are clearly encompassed within the present invention.

### Infusion and Extraction

Optimizer Design and Operation

Referring to FIG. 1A, an optimizer 102 can perform simultaneous infusion of bulking agents and extraction of organic acids by contacting a fruit with an infusion/extraction syrup. An optimizer is an exchange apparatus configured to facilitate exchange of chemical components between fruit and an infusion/extraction syrup therein. An infusion/extraction syrup may be a deacidified fruit or vegetable juice. An infusion/extraction syrup may be a sugar solution containing at least the same concentrations of glucose and fructose as the fruit itself, namely about 4% glucose and about 1% fructose in case of cranberries. In addition, an infusion/extraction syrup may also contain other bulking agents, such as maltodextrin and/or other long chain molecules. The infusion/extraction syrup is fed into the optimizer 102 by line 104. The fruit in this example is separately fed into the optimizer 102 by line 106. The optimizer 102 can include, e.g., a countercurrent infuser/extractor. The optimizer may also include a device configured to expose the flesh of the fruit to facilitate exchange of chemical components between the fruit and the infusion/extraction syrup, e.g., a scarifier, slicer, pricking device, pitting device, etc., or any combination thereof. This device may be separate from, e.g., the countercurrent infuser/extractor, or may be incorporated into a countercurrent infuser/extractor apparatus, such that the flesh of the fruit is exposed as the fruit is introduced into the infuser/extractor. The optimizer 102 can include variable transportation flutes such that a mechanical motion occurs to facilitate the exchange of fluids between the fruit and the infusion/extraction syrup. The optimizer 102 can include an enhanced pulsing mechanism, such as ultrasound, to disrupt the surface tension of fluid and enhance the mass transport process.

Inside the optimizer 102, fruit or vegetables are contacted with an infusion/extraction liquid to bring about the exchange of chemical components (e.g. acids, sugars, and/or other soluble solids) with the liquid. In some implementations, the optimizer 102 may be a single-function unit (e.g., configured to perform only infusion/extraction). In some implementations, the optimizer 102 may be a multi-function unit (e.g., configured to scarify and/or defrost and/or perform infusion/extraction). In some implementations, the optimizer 102 may include a set of single- or multi-function units, each connected, for example, by lines. In some implementations, the optimizer 102 may include multiple interconnected single- or multifunction units.

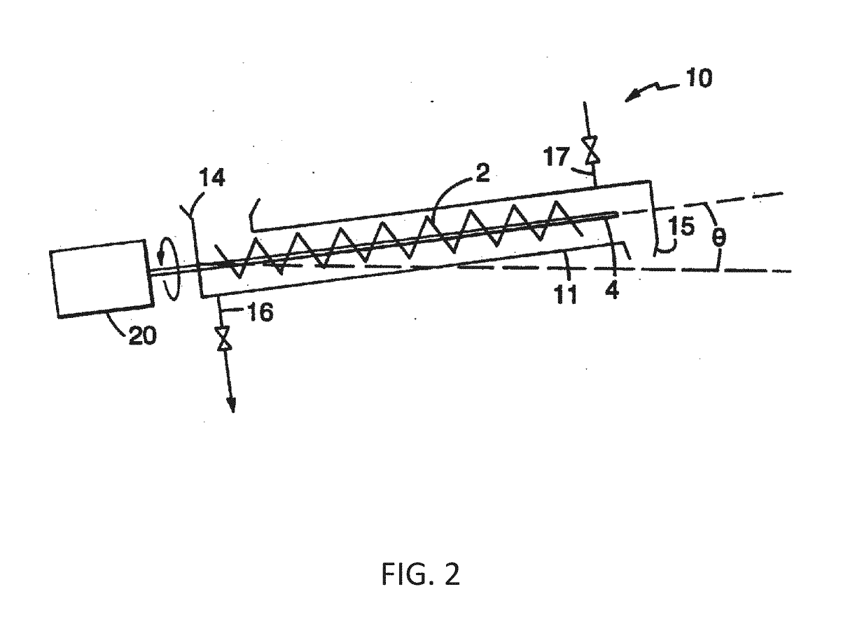

The optimizer 102 may be, or may include, for example, a countercurrent infusion unit, a countercurrent extraction unit, or both. Referring to FIG. 2, a countercurrent extraction apparatus 10 may be used as an optimizer as described above. A trough-shaped housing 11 with a helical screw conveyor 2 intermittently rotated by a motor means 20, connected to a shaft 4 on its longitudinal axis. Housing 11 has an inlet hopper 14 for the introduction of material to be extracted, particularly raw cranberries, and an outlet 15 at the other end of the trough housing is provided for removal of extracted and infused fruit pieces. The inlet hopper 14 is disposed above the lower end of the screw which is inclined slightly upwardly at angle Θ. A charging line 17 is provided for charging extraction liquid, which may be an infusion/extraction syrup, into the housing 11 and a discharge line 16 for the discharge of liquid extract, a spent infusion/extraction syrup. The trough temperature may be controlled (e.g., by heating or cooling with a circulating water jacket (not shown) positioned about the trough) to control the process temperature. Alternatively, or in addition, the temperature of the fruit or extraction liquid may be preselected prior to introduction to the extractor. The screw conveyor is operated by intermittently reversing the direction of rotation of the screw. The reversal helps the relatively compacted mass of matter (the fruit) being extracted to be opened up, enhancing penetration of the infusion/extraction syrup. Parameters for operation of an example countercurrent apparatus as shown in FIG. 2 for extraction of cranberries are given in Table I below. Skilled practitioners will appreciate that these parameters may be adjusted based on a type of fruit and a type of countercurrent apparatus being used.

TABLE I

| Process Variable | Range |
|---|---|
| Inclined angle θ (degrees) | 2 to 20 |
| Process temperature (deg. F.) | 45 to 125 |
| Fruit residence time (minutes) | 30 to 180 |
| Screw rotation (rpm) | 1 to 4 |
| Water/fruit feed rate ratio (weight ratio) | 2:1 to 8:1 |

In another example, enhancing the rates of extraction and infusion may be achieved by applying pressure, applying vacuum, or pressure and vacuum in alternating sequence, during the infusion/extraction process.

A pressure of about 0 MPa to 100 MPa, for example, about 0 MPa to about 20 MPa, about 0 MPa to about 40 MPa, about 0 MPa to about 60 MPa, about 0 MPa to about 80 MPa, about 20 MPa to about 40 MPa, about 20 MPa to about 60 MPa, about 20 MPa to about 80 MPa, about 20 MPa to about 100 MPa, about 40 MPa to about 60 MPa, about 40 MPa to about 80 MPa, about 40 MPa to about 100 MPa, about 60 MPa to about 80 MPa, about 60 MPa to about 100 MPa, about 80 MPa to about 100 MPa, or about 0 MPa, about 20 MPa, about 40 MPa, about 60 MPa, about 80 MPa, or about 100 MPa may be used to enhance infusion. A vacuum of about 0 in Hg to about 20 in Hg, for example, about 0 in Hg to about 5 in Hg, about 0 in Hg to about 10 in Hg, about 0 in Hg to about 15 in Hg, about 5 in Hg to about 10 in Hg, about 5 in Hg to about 15 in Hg, about 5 in Hg to about 20 in Hg, about 10 in Hg to about 15 in Hg, about 10 in Hg to about 20 in Hg, about 15 in Hg to about 20 in Hg, or about 0 in Hg, about 5 in Hg, about 10 in Hg, about 15 in Hg, or about 20 in Hg may be used to enhance extraction and/or infusion. Skilled practitioners will appreciate that a pressure within the optimizer will reduce osmotic dehydration, while a vacuum within the optimizer will enhance osmotic dehydration. Therefore, an alternating pressurized and vacuum system may results in a maximally efficient extraction and infusion. The infusion and extraction operation may be carried out at room temperature (about 72° F.) or at a higher temperature up to about 120° F. For example, a temperature range between about 70° F. to about 120° F. (e.g., about 70° F. to about 80° F., about 70° F. to about 90° F., about 70° F. to about 100° F., about 70° F. to about 110° F., about 80° F. to about 90° F., about 80° F. to about 100° F., about 80° F. to about 110° F., about 80° F. to about 120° F., about 90° F. to about 100° F., about 90° F. to about 110° F., about 90° F. to about 120° F., about 100° F. to about 110° F., about 100° F. to about 120° F., about 110° F. to about 120° F., or about 70° F., about 80° F., about 90° F., about 100° F., about 110° F., or about 120° F.) may be used.

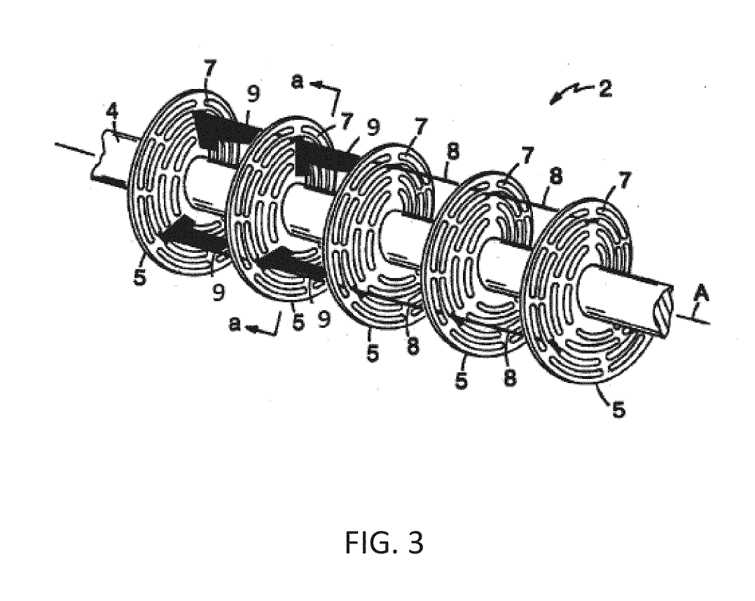

Referring now to FIG. 3, in a countercurrent infusion apparatus, the screw conveyor 2 includes a series of vertical, helical flights 5, optionally having wire or rod longitudinal members 8 positioned between adjacent flights and extending longitudinally generally parallel to the conveyor shaft 4 which has an axis A (corresponding to the axis of the flight). The screw conveyor 2 also includes at least one paddle 9. In some implementations, where more than one paddle is included, the paddles 9 can be spaced about 180° from one another. In some implementations, the paddles 9 can be placed along a beginning portion of the screw conveyor 2. In some implementations, the paddles 9 may be welded to the screw conveyor 2 or co-formed with the screw conveyor 2 (e.g., to form a unitary structure, e.g., made of metal or plastic, comprising at least one paddle). In other implementations, the paddles 9 may be attached to a screw conveyor 2 with a bracket. In these implementations, the paddles 9 may be repositionable. The spacing between and the number of paddles can vary and may be selected to provide maximum extraction/infusion without interfering with production flow or causing backups in the system.

Other details of a suitable countercurrent extractor are described in U.S. Pat. No. 4,363,264, and in U.S. Provisional Patent Application No. 62/503,876 the entire contents of which are hereby incorporated by reference. Commercially available fruit extractor units (e.g., CCE Model 275, Howden Equipment Services Pty, Ltd., Sydney, Australia) may be modified and operated with beneficial results as described further below.

In a first implementation, an extraction or infusion vessel configured to allow the fruit to be fully flooded (i.e., totally submerged) in a sealed chamber may be used. A sealed chamber allows for pressure or vacuum to be applied. In such an implementation, the fruit is transported from a rear portion of the vessel to a front portion of the vessel via a ribbon blending apparatus. The vessel is horizontal with a slight incline. The vessel may include multiple liquid injection nozzles configured to pressurize a flow through a constriction velocity design. A pressurized flow enhances fruit movement and fruit to liquid contact in the vessel. The vessel may also have multiple inlets and/or multiple outlets to maintain gradient. The vessel may also be configured to pull a vacuum or be pressurized through additional ports in the vessel. Further operating parameters for the extraction or infusion vessel are described below.

In a second implementation, a multi-stage vessel configured to facilitate contacting the fruit with differing liquids may be used. Transfers between the differing chambers in the vessel may be accomplished via a gasketed barrier and/or via a stator-rotor design. The multi-stage vessel may also be configured to pull a vacuum or be pressurized through additional ports in the unit. Further operating parameters for the multi-stage vessel are described below.

In a third implementation, a low-shear positive displacement pump may be used to introduce fruit from a hopper to a length of pipe carrying extraction/infusion fluid. Mass transfer in this co-current flow configuration can be manipulated by controlling a fruit to fluid ratio, a fluid temperature, a fluid flow, and a cycling of pressure within the pipe. Further operating parameters for this low-shear implementation are described below.

For the three implementations discussed above (extraction or infusion vessel, multi-stage, low-shear), a fruit temperature inlet may be between about 28° F. and 85° F., for example, about 28° F. to about 32° F., about 28° F. to about 40° F., about 28° F. to about 50° F., about 28° F. to about 60° F., about 28° F. to about 70° F., about 28° F. to about 80° F., about 28° F. to about 85° F., about 32° F. to about 40° F., about 32° F. to about 50° F., about 32° F. to about 60° F., about 32° F. to about 70° F., about 32° F. to about 80° F., about 32° F. to about 85° F., about 40° F. to about 50° F., about 40° F. to about 60° F., about 40° F. to about 70° F., about 40° F. to about 80° F., about 40° F. to about 85° F., about 50° F. to about 60° F., about 50° F. to about 70° F., about 50° F. to about 80° F., about 50° F. to about 85° F., about 60° F. to about 70° F., about 60° F. to about 80° F., about 60° F. to about 85° F., about 70° F. to about 80° F., about 70° F. to about 85° F., about 80° F. to about 85° F., or about 28° F., about 30° F., about 40° F., about 50° F., about 60° F., about 70° F., about 80° F., or about 85° F.

For the three implementations discussed above (extraction or infusion vessel, multi-stage, low-shear), a syrup inlet temperature may be about 60° F. to about 120° F., for example, about 60° F. to about 70° F., about 60° F. to about 80° F., about 60° F. to about 90° F., about 60° F. to about 100° F., about 60° F. to about 110° F., about 70° F. to about 80° F., about 70° F. to about 90° F., about 70° F. to about 100° F., about 70° F. to about 110° F., about 70° F. to about 120° F., about 80° F. to about 90° F., about 80° F. to about 100° F., about 80° F. to about 110° F., about 80° F. to about 120° F., about 90° F. to about 100° F., about 90° F. to about 110° F., about 90° F. to about 120° F., about 100° F. to about 110° F., about 100° F. to about 120° F., about 110° F. to about 120° F., or about 60° F., about 70° F., about 80° F., about 90° F., about 100° F., about 110° F., or about 120° F.

For the three implementations discussed above (extraction or infusion vessel, multi-stage, low-shear), a residence time for fruit within the vessel may be between about 12 minutes and 100 minutes, for example about 12 minutes to about 20 minutes, about 12 minutes to about 40 minutes, about 12 minutes to about 60 minutes, about 12 minutes to about 80 minutes, about 20 minutes to about 40 minutes, about 20 minutes to about 60 minutes, about 20 minutes to about 80 minutes, about 20 minutes to about 100 minutes, about 40 minutes to about 60 minutes, about 40 minutes to about 80 minutes, about 40 minutes to about 100 minutes, about 60 minutes to about 80 minutes, about 60 minutes to about 100 minutes, about 80 minutes to about 100 minutes, or about 12 minutes, about 20 minutes, about 40 minutes, about 60 minutes, about 80 minutes, or about 100 minutes.

For the three implementations discussed above (extraction or infusion vessel, multi-stage, low-shear), a syrup to berry ratio may be between about 0.5:1 to about 5:1, for example about 0.5:1 to about 1:1, about 0.5:1 to about 2:1, about 0.5:1 to about 3:1, about 0.5:1 to about 4:1, about 1:1 to about 2:1. about 1:1 to about 3:1, about 1:1 to about 4:1, about 1:1 to about 5:1, about 2:1 to about 3:1, about 2:1 to about 4:1, about 2:1 to about 5:1, about 3:1 to about 4:1, about 3:1 to about 5:1, about 4:1 to about 5:1, or about 0.5:1, about 1:1, about 2:1, about 3:1, about 4:1, or about 5:1.

For the three implementations discussed above (extraction or infusion vessel, multi-stage, low-shear), a pressure range of about 0 MPa to about 100 MPa, for example, for example, about 0.1 MPa to about 0.2 MPa, about 0.1 MPa to about 0.3 MPa, about 0.1 MPa to about 0.4 MPa, about 0.1 to about 0.5 MPa, about 0.1 to about 0.6 MPa, about 0.1 to about 0.7 MPa, about 0.1 to about 0.8 MPa, about 0.1 to about 0.9 MPa, about 0.1 MPa to about 1 MPa, about 0.2 MPa to about 0.3 MPa, about 0.2 MPa to about 0.4 MPa, about 0.2 to about 0.5 MPa, about 0.2 to about 0.6 MPa, about 0.2 to about 0.7 MPa, about 0.2 to about 0.8 MPa, about 0.2 to about 0.9 MPa, about 0.2 MPa to about 1 MPa, about 0.3 MPa to about 0.4 MPa, about 0.3 to about 0.5 MPa, about 0.3 to about 0.6 MPa, about 0.3 to about 0.7 MPa, about 0.3 to about 0.8 MPa, about 0.3 to about 0.9 MPa, about 0.3 MPa to about 1 MPa, about 0.4 to about 0.5 MPa, about 0.4 to about 0.6 MPa, about 0.4 to about 0.7 MPa, about 0.4 to about 0.8 MPa, about 0.4 to about 0.9 MPa, about 0.4 MPa to about 1 MPa, about 0.5 to about 0.6 MPa, about 0.5 to about 0.7 MPa, about 0.5 to about 0.8 MPa, about 0.5 to about 0.9 MPa, about 0.5 MPa to about 1 MPa, about 0.6 to about 0.7 MPa, about 0.6 to about 0.8 MPa, about 0.6 to about 0.9 MPa, about 0.6 MPa to about 1 MPa, about 0.7 to about 0.8 MPa, about 0.7 to about 0.9 MPa, about 0.7 MPa to about 1 MPa, about 0.8 to about 0.9 MPa, about 0.8 MPa to about 1 MPa, about 0.9 MPa to about 1 MPa, about 1 MPa to about 2 MPa, about 1 MPa to about 5 MPa, about 1 MPa to about 10 MPa, about 2 MPa to about 3 MPa, about 2 MPa to about 5 MPa, about 2 MPa to about 10 MPa, about 3 MPa to about 5 MPa, about 3 MPa to about 10 MPa, about 5 MPa to about 10 MPa, about 0 MPa to about 20 MPa, about 0 MPa to about 40 MPa, about 0 MPa to about 60 MPa, about 0 MPa to about 80 MPa, about 20 MPa to about 40 MPa, about 20 MPa to about 60 MPa, about 20 MPa to about 80 MPa, about 20 MPa to about 100 MPa, about 40 MPa to about 60 MPa, about 40 MPa to about 80 MPa, about 40 MPa to about 100 MPa, about 60 MPa to about 80 MPa, about 60 MPa to about 100 MPa, about 80 MPa to about 100 MPa, or about 0 MPa, about 0.1 MPa, about 0.2 MPa, about 0.3 MPa, about 0.4 MPa, about 0.5 MPa, about 0.6 MPa, about 0.7 MPa, about 0.8 MPa, about 0.9 MPa, about 1 MPa, about 2 MPa, about 3 MPa, about 5 MPa, about 10 MPa, about 20 MPa, about 40 MPa, about 60 MPa, about 80 MPa, or about 100 MPa, may be used to enhance infusion as described above.

For inclined vessels, an incline angle may be between about 0 degrees and about 15 degrees, for example, about 0 degrees to about 5 degrees, about 0 degrees to about 10 degrees, about 0 degrees to about 12 degrees, about 0 degrees to about 14 degrees, about 0 degrees to about 15 degrees, about 5 degrees to about 10 degrees, about 5 degrees to about 12 degrees, about 5 degrees to about 14 degrees, about 5 degrees to about 15 degrees, about 10 degrees to about 12 degrees, about 10 degrees to about 14 degrees, about 10 degrees to about 15 degrees, about 12 degrees to about 14 degrees, about 12 degrees to about 15 degrees, about 14 degrees to about 15 degrees, or about 0 degrees, about 5 degrees, about 10 degrees, about 12 degrees, about 14 degrees, or about 15 degrees.

Infusion/Extraction Syrup Composition

An infusion/extraction syrup fed to the optimizer 102 by line 104 in FIG. 1A has a lower concentration of organic acids than the concentration of organic acids present in the fruit. As such, when the infusion/extraction syrup contacts the fruit, organic acids in the fruit will flow down the concentration gradient, i.e., out of the fruit and into the infusion/extraction syrup. The infusion/extraction syrup has a greater than or equal to concentration of sugars (e.g. fructose, glucose) compared to the sugar concentrations of the fruit. For example, in an infusion/extraction syrup for infusion/extraction of cranberries, the infusion/extraction syrup can be at least 1% fructose and the infusion/extraction syrup can be at least 4% glucose to match the fructose and glucose concentrations found in cranberries. As such, sugar will be less or not induced to flow out of the fruit and into the infusion/extraction syrup, and, if the concentration of sugars in the infusion/extraction syrup is higher than the concentration of sugars in the fruit, additional sugar will be infused into the fruit from the syrup. Alternatively, or in addition, the infusion/extraction syrup may include bulking agents to be infused into the fruit. Bulking agents may include, but are not limited to, fructose, glucose, sucrose, sugar alcohols, maltodextrins, other dextrins and glucans, fructans, and other soluble fibers such as hydrolyzed guar gum, and soluble corn fiber and small peptides and amino acids, or any combination of such bulking agents.

In cases where the infusion/extraction syrup contains quantities of glucose higher than desirable (e.g., higher than about 4%), an enzymatic treatment with e.g., glucose isomerase may be incorporated to convert a portion of glucose to the sweeter tasting fructose moiety. The incomplete conversion of glucose to fructose via enzymes would be designed to allow at least 4% glucose to remain in the infusion/extraction syrup.

In another implementation, the infusion/extraction syrup may include an emulsion with non-polar molecules in a mixed oil and water media. Non-polar molecules can be derived from, for example, cranberry seed oil, and may introduce bulk into the fruit in the place of a sugar. The non-polar target molecules may include, but are not limited to, tocopherols (alpha, beta, gamma, and/or delta isomers), tocotrienols (alpha, beta, gamma, and/or delta isomers), omega 3-fatty acids such as alpha linoleic acid, etc. These target molecules for infusion will have a carbon to oxygen ratio ranging from 18:2 to 28:2 and degrees of unsaturation ranging from 4 to 9.

Insoluble Fiber to Soluble Fiber Conversion for Use as Bulking Agent

In yet another implementation, the infusion/extraction syrup may include soluble fiber created from cellulosic biomass material derived from fruit. Cellulosic biomass material may, for example, be derived from cranberries, or other fruit or vegetables, or may be whole, chopped, or scarified fruit or vegetables. For example, in some instances lignocellulosic biomass material from cranberry pomace (leftover cranberry hull material after a mashing process) or cranberry presscake (leftover cranberry hull material after a juice extraction process) may be used. Typically, cranberry pomace and presscake are thought of as byproducts of other processes, e.g. the mash process and juice extraction processes mentioned above. In other instances, pulps rich in cellulosic biomass material from other fruit and vegetable sources may be used. Traditional methods of converting insoluble fiber to soluble solids also often focus on increasing hydrogen bonding between water and the cellulose material. Using a method for converting insoluble fiber to soluble solids as described herein avoids the strong acid or base pretreatment which may damage micronutrients present with the cellulosic biomass. Additionally, certain methods described herein focus on disrupting inter-cellulose hydrophobic interactions, rather than traditional methods of disrupting inter-cellulosic hydrogen bonding. Water at high temperature behaves like a non-polar solvent. This property, along with the amphiphilic and non-polar molecules already present in the biomass helps disrupt the hydrophobic interactions within the cellulose molecules allowing cellulose to swell. The swelling of cellulose may be enhanced by addition of other amphiphilic molecules.

As the fruit contacts the infusion/extraction syrup in optimizer 102, organic acids are removed from the fruit and bulking agents (in some instances including sugars) are introduced into the fruit, thereby raising the sugar to acid ratio of the fruit. The ratio of organic acids can be controlled by the composition of the infusion syrup such that a final cranberry fruit product can have a ratio of between 1.0:1.0:0.8 Quinic:Citric:Malic, corresponding to a natural product, to an enhanced quinic acid product with a ratio of 10.0:1.0:2.0 Quinic:Citric:Malic. The infusion/extraction process in optimizer 102 results in a deacidified and infused fruit product. The fruit product can be further optimized for a combination of quinic, citric and malic acids (described here as a “total acids” content) to phenolics and/or PAC (proanthocyanidin) ratios. A total acid to phenolic ratio may be less than about 4:1 by weight, less than about 3:1 by weight, or less than about 1:1 by weight. A quinic acid to total phenolics ratio may be less than 6:1. A total acids to PACs ratio may be less than 3:1. The total acid to phenolics ratios may be achieved by implementing recovery steps, such as ultrafiltration or an adsorption chromatography and/or subsequent quinic acid extraction, to the spent infusion/extraction syrup. The total acid to phenolics ratios may be achieved by adding presscake extracts when introducing soluble fiber. Systems and methods for producing proanthocyanidin extracts (e.g., extracts from presscake) are described in U.S. Pat. No. 9,420,812, the entirety of which is incorporated by reference.

### Methods for Measuring Phenolics in Compositions

Total phenolics for the compositions described herein were measured by the Folin-Ciocalteu method. In an exemplary method, Folin-Ciocalteu Phenol Reagent 2N (MP Biomedical LLC), was diluted to 10× solution in deionized water and stored in an amber bottle. Anhydrous sodium carbonate (Sigma-Aldrich) was dissolved in deionized water to a 7.5% solution then placed on a heated stir plate until well-mixed. The mixture was left to cool to room temperature then stored in an amber bottle. Samples were diluted in deionized water. 100 uL of the prepared samples were added to glass culture tubes. 100 ul of deionized water was added to a glass culture tube to be used as a blank. 3.9 ml of deionized water was then added to each tube and vortexed. 250 uL of 10×2N Folin-Ciocalteu reagent was then added to each glass culture tube then vortexed. 750 uL of 7.5% sodium carbonate solution was added to each glass culture tube then vortexed. The samples were then stored in a dark cabinet for 30 minutes. The samples were taken out then measured at 765 nm on a Hach DR3900 (1.13 cm path length) using the deionized water sample as a blank (Singleton, V. and Rossi, J. 1965. Colorimetry of Total Phenolics with Phosphomolybdic-Phosphotungstic Acid Reagents. Am J Eno and Vitic. 16: 144-158.).

0.5% gallic acid (Sigma-Aldrich) solution was prepared. A standard curve was made containing 0-200 mg/L and measured as stated above. Any sample result that was out of range of the standard curves absorbance range was rerun at a better dilution to achieve an absorbance within the standard curve range. A control sample that had been tested and verified was also measured each run. Results are reported as mg/g Gallic Acid Equivalent (GAE).

### Methods for Measuring Organic Acids in Compositions

Analyses of organic acid contents of the compositions described herein were performed on a Dionex ICS-2100 Ion Chromatography System (Thermo Scientific Sunnyvale, Calif., USA) equipped with an EG40 Eluent Generator, an ASRS 300, 4 mm suppressor, and a CR-ATC. The separation of the organic acids was carried out on a RFIC IonPac AS11-HC, Analytical, 4×250 mm ion exchange column, connected from a RFIC IonPac AG11-HC, 4×50 mm guard column and measured by suppressed conductivity detection. A stock standard containing citric acid, malic acid, and quinic acid is prepared in deionized water to a concentration of 5%. The stock standard is then diluted to prepare working standards of 5, 25, and 50 mg/L, which are used to calibrate the instrument.

### Methods for Measuring Proanthocyanidins in Compositions

The levels of PACs in the compositions described herein have been assessed or quantified using Ocean Spray's dimethylaminocinnameldehyde (DMAC) method, which utilizes PACs fractionated from specific cranberry sources as a standard. See, e.g., Martin et al., Food Res Int 71:68-82, 2015; and de Pascual-Teresa et al., J Agric Food Chem 46:4209-4213, 1998, which are hereby incorporated by reference. Skilled practitioners will appreciate that other methods can be used. For example, Brunswick Labs uses a pure commercially available procyanidin A-2/B-2standard (dimer) as a standard. See, e.g., Prior et al., J Sci Food Agric 90:1473-1478, 2010. When a sample is tested for PACs with Ocean Spray's method compared to Brunswick Labs' method, lower PAC values are consistently found using Brunswick Labs' method due to the lower molecular weight of the procyanidinA-2/B-2standard compared to the fractionated PAC standard, which contains A-2/B-2and all the higher molecular weight PAC oligomers and polymers present in cranberries. For example, a sample that has about 110 mg PACs when tested using Ocean Spray's DMAC method, may have only about 36 mg PACs when tested using Brunswick Labs' DMAC method.

Skilled practitioners will recognize that both methods measure the total PACs in a sample, but they differ only in how the results are expressed based on the chosen standard equivalency. Therefore, while the results may differ in using the two methods on the same sample, it does not mean that the levels are different. As a result, it is recommended that testing comparisons of the same material always be made using the same methodology so as to avoid confusion. Both methods are generally used in the industry. Nonetheless, Ocean Spray's method better represents the PACs found in cranberry and therefore, results obtained by this method are a truer representation of the ‘real’ amount of PACs in cranberry samples. Accordingly, all PAC values described herein (and ratios of PACs to other components) are determined using Ocean Spray's DMAC method.

In an example of executing the Ocean Spray DMAC method, a Sephadex LH-20 column separation followed by the absorbance measurement of DMAC colorimetric reaction was used to determine PAC content in cranberry samples (Cunningham, D., Vannozzi, S., O'Shea, E., & Turk, R. 2002. Quality Management of Nutraceuticals ACS Symposium series 803, Washington D.C.). A 1.0 g aqueous sample was loaded onto a pre-hydrated Sephadex LH-20 polyprep column. Distilled water (10 mL), then 25% EtOH (10 mL) solution were used to elute off the sugars, organic acids, anthocyanins, and flavonols. These eluents were discarded. The columns were then washed sequentially with 70% acetone in water solution (2.5 mL then another 2.5 mL), collected, and combined in a 15 mL tube. The samples were vortexed then 1 mL of the sample was added to a glass culture tube. 1% DMAC (in 70/30 MeOH/HCl) was prepared with 3 mL being added to each culture tube, including reagent blank. The tubes were vortexed and then the absorbance was measured after 5 min at 640 nm on a Hach DR3900. The regent blank was used to zero the spectrophotometer. Samples needed to be in the optimal range of 0.2-0.8 with samples outside of this range being rerun with dilutions accordingly adjusted. The PACs concentrations of the samples were calculated as is and reported in mg/kg.

### Defrosting

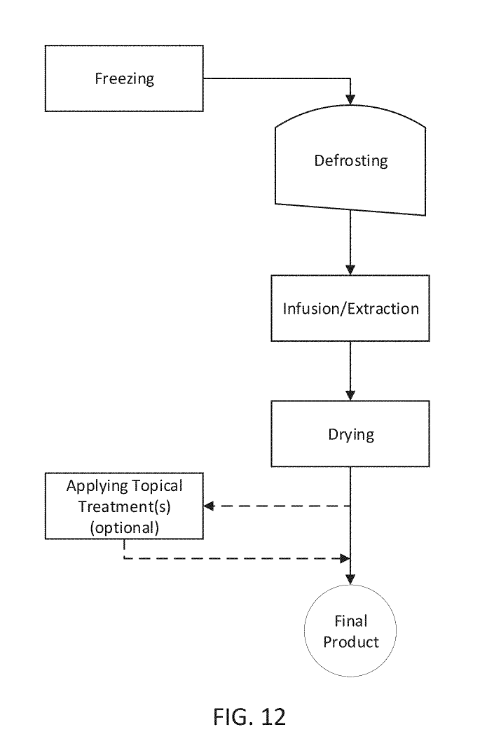

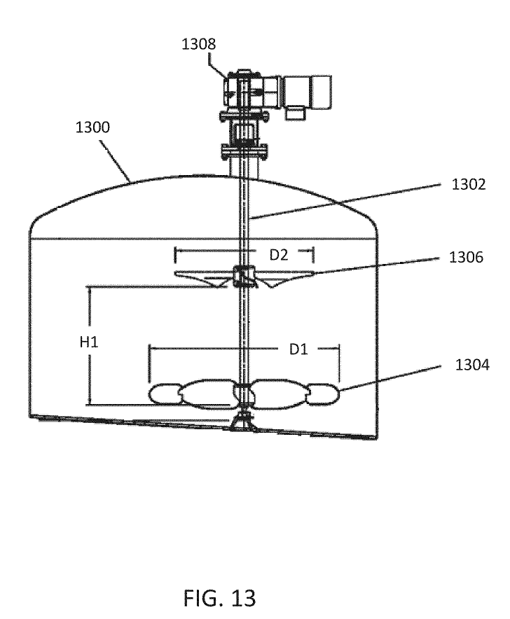

In order to facilitate the transfer of molecules, it may be beneficial to defrost or partially defrost frozen berries before they are introduced into the optimizer 102 as described above. An example process including a defrost tank is shown in FIG. 12, wherein frozen berries are defrosted in a defrost tank (as will be discussed with respect to FIGS. 13-16) before moving into an infusion/extraction step in optimizer 102. From the infusion/extraction step in optimizer 102 (where infused/extracted berries exit the optimizer through line 156 in FIG. 1A) the berries are dried. Skilled practitioners will appreciate that the infused/extracted berries may be dried using a variety of methods, including vacuum drying, etc. Topical treatments, such as coatings, powders, etc., may be added to the dried infused/extracted berries to produce a final product. The final product may be, for example, a sweetened and dried cranberry. Scarified frozen berries may be defrosted while the berries are in the optimizer before the exchange of chemical components takes place between the syrup and the berries. Skilled practitioners will appreciate that in order to increase efficiency in the optimizer, the berries are optionally introduced into a fruit-defrosting suspension tank (“defrost tank”) that includes a low-shear agitator alongside a liquid media. The frozen berries are introduced, through a first inlet, to the defrost tank at a first temperature of about 10° F. to about 32° F., for example about 10° F. to about 24° F., about 10° F. to about 28° F., for example about 20° F. to about 24° F., about 20° F. to about 28° F., about 20° F. to about 32° F., about 24° F. to about 28° F., about 24° F. to about 32° F., about 28° F. to about 32° F., or about 10° F., about 20° F., about 24° F., about 28° F., or about 32° F. Liquid media is continuously supplied to the defrost tank low-shear agitator through a second inlet at a second temperature of about 60° F. to about 120° F., for example, about 60° F. to about 70° F., about 60° F. to about 80° F., about 60° F. to about 90° F., about 60° F. to about 100° F., about 60° F. to about 110° F., about 60° F. to about 120° F., about 70° F. to about 80° F., about 70° F. to about 90° F., about 70° F. to about 100° F., about 70° F. to about 110° F., about 70° F. to about 120° F., about 80° F. to about 90° F., about 80° F. to about 100° F., about 80° F. to about 110° F., about 80° F. to about 120° F., about 90° F. to about 100° F., about 90° F. to about 110° F., about 90° F. to about 120° F., about 100° F. to about 110° F., about 100° F. to about 120° F., about 110° F. to about 120° F., or about 70° F., about 80° F., about 90° F., about 100° F., about 110° F., or about 120° F. As the liquid media and the berries are mixed, the berries are suspended in the liquid media, increasing the efficiency of the defrosting process.

Referring to FIG. 13, the defrost tank 1300 has a shaft 1302 with a first impeller 1304 and a second impeller 1306 attached. The shaft 1302 is rotated by a motor 1308. The first impeller 1304 and the second impeller 1306 are separated by a height H1 within the defrost tank 1300. The first impeller 1304 rotates to produce low shear agitation in the defrost tank 1300. The low shear agitation mixes the frozen berries with the liquid media to equalize the temperature of the berries with the temperature of the liquid media, defrosting the berries. The low shear agitation mixes and defrosts the berries with minimal damages to the berries such that the berries maintain their structural integrity during the defrosting process.

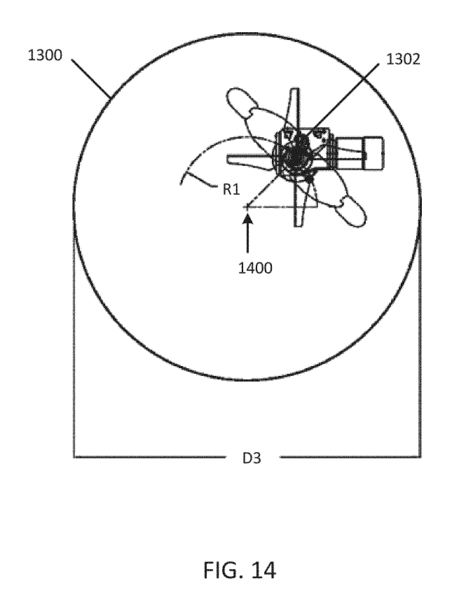

In the defrost tank 1300, the first impeller 1304 circulates the berries and liquid media vertically about the defrost tank 1300. As shown in the top view of the defrost tank 1300 shown in FIG. 14, the shaft 1302 is offset from a center 1400 of the defrost tank 1300 by a distance R1. The defrost tank has a diameter D3. In some implementations, the ratio of twice R1 (equal to diameter of the second impeller 1306) to D3 is approximately 0.64. The offset (here of a distance R1) increases the efficiency of the mixing because it decreases the likelihood that the rotation of the first and second impellers 1304, 1306 will cause the berries and liquid media to swirl around in the defrost tank 1300 about the center 1400. The offset of the shaft 1302 helps the first impeller 1304 to produce a vertical flow pattern in the defrost tank 1300.

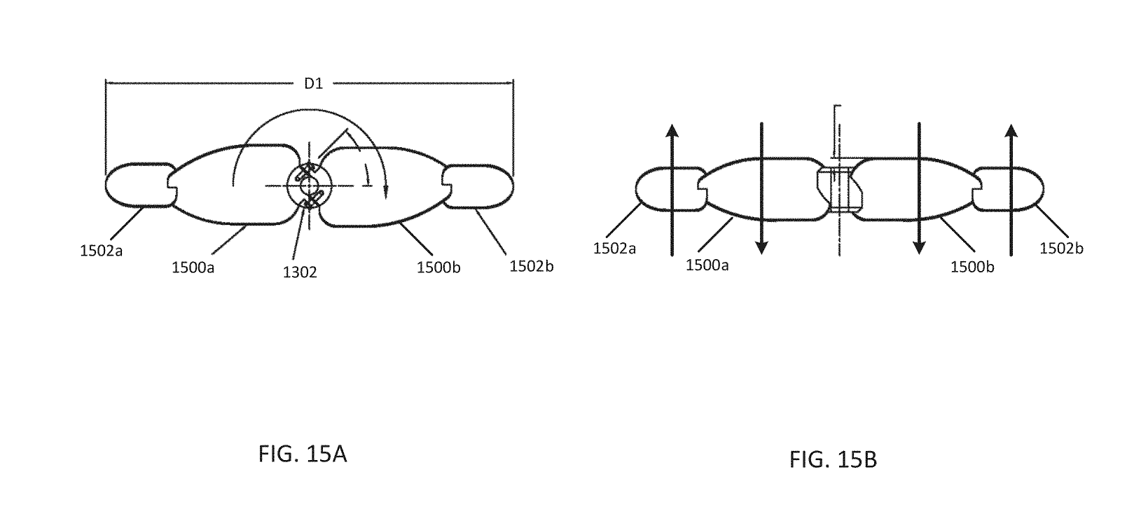

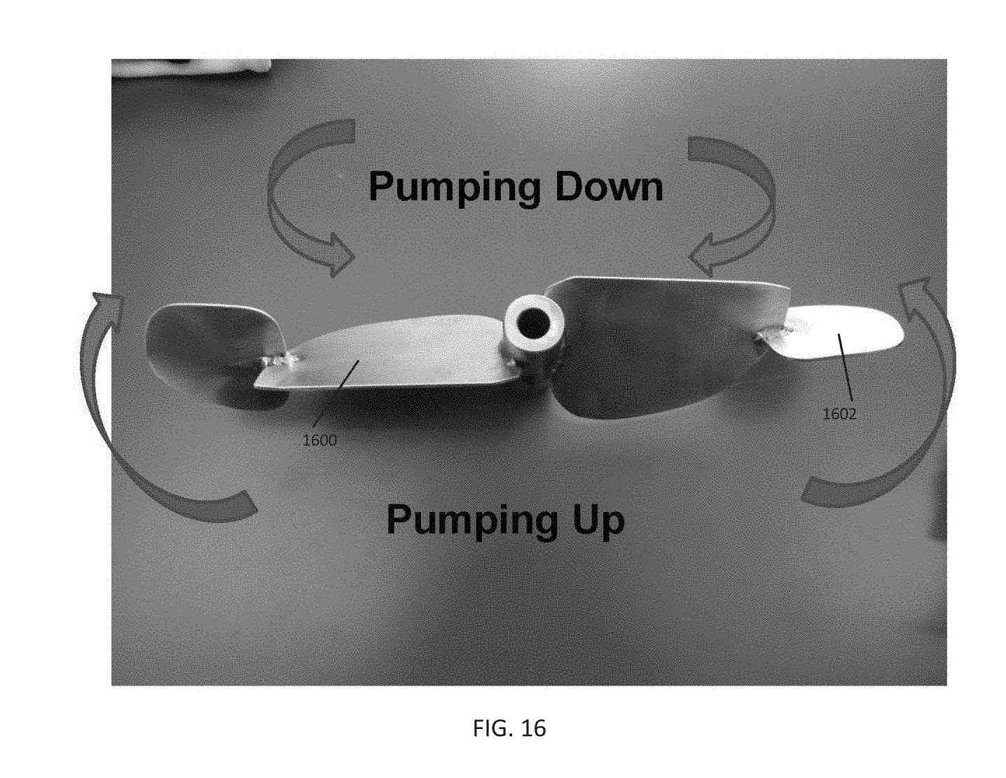

The geometry of the first impeller 1304 also helps to drive the liquid media and berries in a vertical flow pattern in the defrost tank 1300. As shown in the top view of the first impeller in FIG. 15A, the first impeller 1304 has a multi-lobed geometry with inner lobes 1500a and 1500b and outer lobes 1502a and 1502b. As the first impeller 1304 rotates with the shaft 1302, the liquid media and berries pass the inner lobes 1500a-b in a first vertical direction and the liquid media and berries pass the outer lobes 1502a and 1502b in a second vertical direction opposite of the first vertical direction. For example, as shown in the side view of the impeller in FIG. 15B, the liquid media and berries flow past the inner lobes 1500a-b in a downward direction and past the outer lobes 1502a-b in an upward direction. A photograph of an example impeller with inner lobe 1600 and outer lobe 1602 is shown in FIG. 16.

In some implementations, there is only one impeller in the tank. In some implementations, multiple impellers may be placed about the defrost tank to produce low shear agitation in the defrost tank. In some implementations, baffles may be used in place of or in addition to one or more impellers to produce low shear turbulence in the defrost tank.

The tank 1300 has an outlet through which defrosted berries and liquid media flow. The temperature of the liquid media and berries at the outlet is between approximately 35° F. and 70° F., for example, about 35° F. to about 50° F., about 35° F. to about 70° F., about 50° F. to about 70° F., or about 35° F., about 50° F., or about 70° F. The volumetric rate of withdrawal out of the outlet of the defrost tank 1300 can be set and adjusted. Upon flowing out of the outlet, the liquid media and berries may be separated from one another in a separator. The separator may for example be a shaker. The defrosted berries, after separation from the liquid media, are transported for further treatment.

The liquid media, after being separated from the berries, may be recycled back to the second inlet of the defrost tank. The temperature of the liquid media after separation is cooler than the temperature of the liquid media entering the tank at the second inlet because the liquid media at the outlet has been cooled by the defrosting berries. As such, the liquid media is warmed to the second temperature (the temperature at the second inlet) before the liquid media is reintroduced into the defrost tank.

The defrosting process in the tank may be accomplished as a continuous process, e.g., the volumetric flow rates into and out of the tank are equal. A residence time of the berries in the tank is between approximately 2 minutes and 30 minutes, for example about 2 minutes to about 5 minutes, about 2 minutes to about 10 minutes, about 2 minutes to about 20 minutes, about 5 minutes to about 10 minutes, about 5 minutes to about 20 minutes, about 5 minutes to about 30 minutes, about 10 minutes to about 20 minutes, about 10 minutes to about 30 minutes, about 20 minutes to about 30 minutes, or about 2 minutes, about 5 minutes, about 10 minutes, about 20 minutes, or about 30 minutes.

To achieve faster defrosting, in some implementations, the defrost tank may be replaced by a flume. When a flume is used, the residence time is reduced to about 5 seconds to about 2 minutes, for example, about 5 seconds to about 10 seconds, about 5 seconds to about 30 seconds, about 5 seconds to about 1 minute, about 10 seconds to about 30 seconds, about 10 seconds to about 1 minute, about 10 seconds to about 2 minutes, about 30 seconds to about 1 minute, about 30 second to about 2 minutes, about 1 minute to about 2 minutes, or about 5 seconds, about 10 seconds, about 30 seconds, about 1 minute, or about 2 minutes. In yet another implementation, a series of tanks or flumes may be used as part of the optimizer.

Fruit and Spent Syrup Removal from Optimizer

The deacidified and infused fruit product can be removed from the optimizer through line 156 and may be transported to a drying process. A spent infusion/extraction syrup, which contains the organic acids extracted from the fruit, may be transported through line 110 to be depectinized via enzymatic degradation, deacidified and further processed for recycling to optimizer 102. The spent infusion/extraction syrup may be an acidified fruit or vegetable juice containing one or more of citric acid, malic acid, and quinic acid. The spent infusion/extraction syrup may be removed through line 108 for further processing for inclusion in a juice or other beverage.

System 100 forms a fluid loop wherein syrup is moved through the different sub-processes described herein (e.g., acid removal, ultrafiltration, evaporation, mixing, etc.) to change the syrup's composition at different points within the fluid loop such that the spent syrup may be continuously recycled.

### Ultrafiltration

The spent infusion/extraction syrup from optimizer 102 in line 110 contains organic acids and long chain molecules extracted from the fruit. For example, for cranberries, proanthocyanidins (PACs) and other phenolics as well as soluble fibers are extracted alongside the organic acids in optimizer 102. Before removing the organic acids from the spent infusion/extraction syrup, the long chain molecules can be removed to reduce interference with the membranes and/or resins used in the organic acid separation process. As such, the spent infusion/extraction syrup in line 110 can be transferred to an ultrafiltration unit 112. The ultrafiltration unit 112, in one example, is an ultrafiltration membrane system including at least one ultrafiltration membrane.

In some implementations, the ultrafiltration unit 112 may include a spiral wound ultrafiltration membrane, such as a Koch Membrane Systems model # 3838K328-NYT spiral wound UF membrane with a 5000 Dalton molecular weight cutoff. A suitable ultrafiltration membrane can have a molecular weight cutoff between about 2,000 and 10,000 Dalton, for example, about 2,000 Dalton, about 3,000 Dalton, about 4,000 Dalton, about 5,000 Dalton, about 6,000 Dalton, about 7,000 Dalton, about 8,000 Dalton, or about 9,000 Dalton, or about 10,000 Dalton, on propylene glycol. When the nominal molecular weight cut-off of the ultrafiltration membrane system is properly selected, a substantial fraction of higher molecular weight PACs (and/or relatively high molecular weight aggregates of PACs and/or other long chain molecules including soluble fiber) present in the spent infusion/extraction syrup are selectively retained in the retentate. A remaining array of constituent lower molecular weight soluble solids (e.g., sugars, acids, anthocyanins, etc.) preferentially pass through the membrane as permeate.

In another implementation, to retain a quantity of anthocyanins, other phenolics, and other molecules that are larger than the sugars and acids but smaller than PACs etc., an ultrafiltration membrane with a smaller molecular weight cut-off may be used. A lower molecular weight cut-off is useful to retain the phenolic compounds in the infusion/extraction syrup. A suitable ultrafiltration membrane to retain anthocyanins and other phenolics can have a molecular weight cutoff of about 200-2,000 Dalton, for example, about 200 Dalton, about 300 Dalton, about 400 Dalton, about 500 Dalton, about 600 Dalton, about 700 Dalton, about 800 Dalton, about 900 Dalton, about 1,000 Dalton, about 1,200 Dalton, about 1,400 Dalton, about 1,600 Dalton, about 1,800 Dalton, or about 2,000 Dalton on propylene glycol. In such an implementation, when the nominal molecular weight cut-off of the membrane system is properly selected, a substantial fraction of medium to high molecular weight fractions, such as anthocyanins, other phenolics, PACs (and/or relatively high molecular weight aggregates of PACs and/or other long chain molecules including soluble fiber) present are selectively retained in the retentate. A remaining array of constituent low molecular weight soluble solids (e.g., sugars, acids, and ions etc.) preferentially pass through the membrane as permeate. The ultrafiltration unit described in this implementation may be used either to replace the unit 112 (configured to retain the higher molecular weight PACs and/or relatively high molecular weight aggregates of PACs and/or other long chain molecules including soluble fiber) or may be used in series with the unit 112. If the units are used in series, the retentates of both the units may be combined and the permeates of both the units may be combined.

In another implementation, the infusion/extraction syrup can be passed over a resin with a high affinity for polyphenols and other phenolic compounds in order to adsorb and extract these compounds, resulting in a permeate rich in sugars and acids, but depleted of polyphenols and other phenolic compounds such as PACs, anthocyanins, and flavonols. The resin is loaded with polyphenols from the infusion/extraction syrup and can subsequently be eluted with a suitable solvent to recover these compounds and regenerate the resin while producing a highly enriched and concentrated stream of polyphenols. This eluent can further be back blended into the infusion syrup to allow for lower ratios of total acids to phenolics. This process may be used as a finishing step to remove residual phenolic compounds from the ultrafiltration permeate or may be used in place of an ultrafiltration process as described above. Systems and methods for extracting phenolics are described in U.S. Pat. No. 9,113,655, the entirety of which is hereby incorporated by reference.

Referring back to FIG. 1A, the long chain molecules (including PACs, other phenolics, and soluble fibers) that are retained in the retentate are fed into line 114. The permeate, containing the filtered spent infusion/extraction syrup, is fed into line 116.

### Acid Removal

The acid removal process described herein describes a method of separating, purifying, and optionally crystallizing organic acids (e.g., citric, malic, and/or quinic acids) from aqueous mixtures of sugars and acids (e.g., from fruit juice, e.g., cranberry juice). As shown in FIG. 1A, the removal of acids (at exchange beds 118, 124) from a spent infusion/extraction syrup (in line 116) allows for the efficient and continuous recycling of that syrup, while yielding streams (in lines 120, 128) of high purity organic acids for use in other processes. The method includes adsorbing the organic acids onto a single anion exchange resin or series of resins and eluting each type of acid from the aqueous mixture separately. The anion exchange resin may be a weak basic anion exchange resin. The resultant organic acid and acid salt solutions may then be re-acidified, if necessary, and recrystallized and dried by freeze, spray, or vacuum drum drying. In some implementations, deacidified juice can be then put through a fermentation process (e.g., fermented by Saccharomyces cerevisiae) to form a fermented product(s) (e.g., a fermented beverage product) or used in other formulations as a sweetener or additive.

Referring to FIG. 1A, the filtered spent infusion/extraction syrup in line 116 is fed to a bed or series of beds containing weak base anion exchange resin. The filtered spent infusion/extraction syrup in line 116 is fed into a first anion exchange bed 118. The anion exchange bed 118 includes an anion exchange resin configured to adsorb citric and malic acids from the filtered spent infusion/extraction syrup.

The filtered spent infusion/extraction syrup may be at a solids content of 1.00-65.00% wet mass. The first anion exchange bed 118 is a column packed with an anion exchange resin. The anion exchange resin may be a FPA 51 Resin manufactured by DOW. FPA 51 resin is a macroporous polystyrene based resin with divinyl benzene co-polymers. The co-polymers provide the resin improved structural durability. The active group that is attached to styrene monomers is a tertiary alkyl amine. Other examples of ion exchange resins that may be used include Monosphere 77 by DOWEX, Amberlite FPA 51, Amberlite FPA 53, Amberlite FPA 54, or Amberlite FPA 55* by DOW, Diaion WA 10*, Diaion WA 20, Diaion WA 30 or Diaion WA21J by Itochu, or A110, A111S, A133S, A120S*, or A149S* by Purolite.

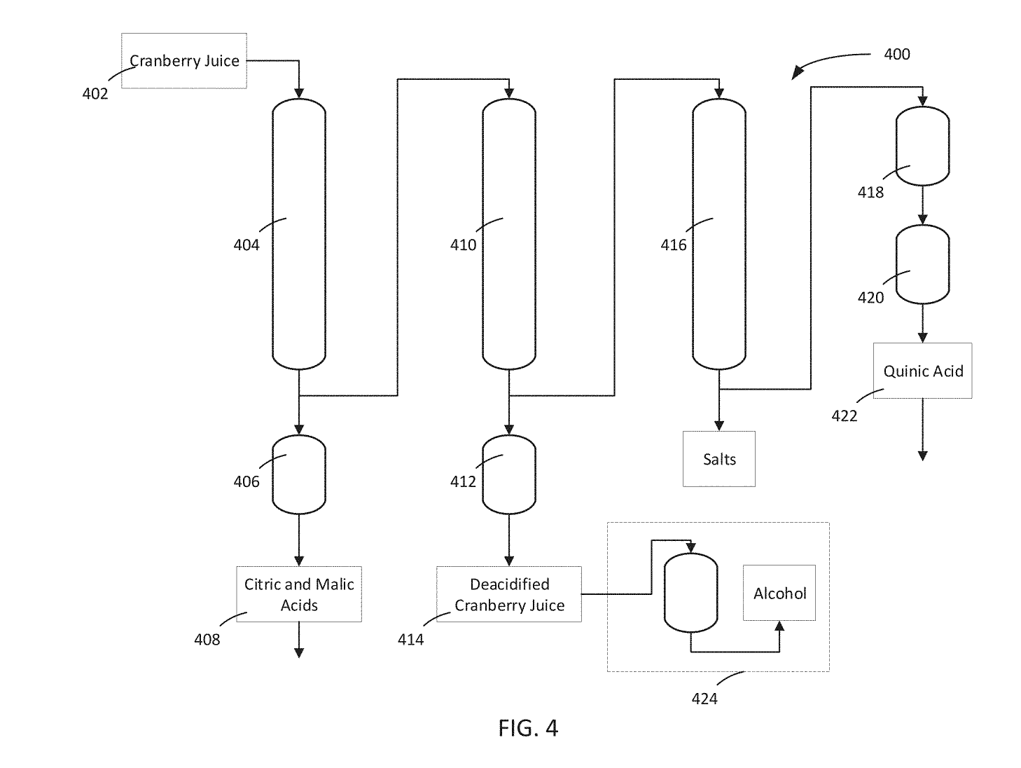

Referring to FIG. 4, a system 400 for extracting and purifying organic acids from cranberry juice concentrate is shown. The system 400 may be integrated with the system 100 of FIG. 1A or the system 1000 of FIG. 1B. The acid extraction process is based on the adsorption of protonated organic acid molecules onto a solid form anion exchange resin. With careful characterization and elution with NaOH or other species with greater affinity to the resin, these acids may be fractionated into aqueous solutions of 2.00-18.00% wet mass. During the course of the chromatography, the pigment molecules found in cranberries can be used as an indicator of eluent pH and acid content. At pH greater than 7.5, the acid content is less than 0.5% wt and the color of natural pigments is greenish yellow. At bed exhaustion and acid leakage, the pigment returns to its characteristic red color as the pH falls to 2.0-4.5.

In FIG. 4, cranberry juice concentrate 402 is flowed into a first anion exchange column 404. The cranberry juice concentrate may be at a solids content of 1.00 to 65.00% wet mass. The first anion exchange column 404 is packed with an anion exchange resin. The anion exchange resin may be a FPA 51 Resin manufactured by DOW. FPA 51 resin is a macroporous polystyrene based resin with divinyl benzene co-polymers. The co-polymers provide the resin improved structural durability. The active group that is attached to styrene monomers is a tertiary alkyl amine. Other examples of ion exchange resins that may be used include DOWEX Monosphere 77, DOW-Amberlite FPA 51, DOW-Amberlite FPA 53, DOW-Amberlite FPA 54, DOW-Amberlite FPA 55*, Itochu-Diaion WA 10*, Itochu-Diaion WA 20, Itochu-Diaion WA21J, Purolite A110, Purolite A111S, Purolite A120S*, and Purolite A149S*.

In some implementations, the anion exchange may take place outside of a column, for example in a batch adsorption process. In such implementations a given volume of fluid would be contacted with a specified depth or amount of resin within a vessel or bed. The amount of resin would be 4.0-6.0 g of resin for each gram of dissolved acid in the feedstock.

Returning to FIG. 4, citric and malic acids are absorbed onto the resin as the cranberry juice concentrate flows through the first anion exchange column 404. With the citric and malic acids being bound by the resin, the column 404 is rinsed with deionized water for characterization. During this characterization (or sweeten-off), partially deacidified cranberry juice (i.e. cranberry juice having reduced citric and/or malic acid content) and quinic acid are collected. The quinic acid is collected trailing the partially deacidified cranberry juice. The acids remaining in the first anion exchange column 404 after the rinse (citric and malic acids) are eluted from the column 404 with sodium hydroxide or another basic solution at a concentration of 0.1 N to 10.0 N. The citric and malic acids may be fed into an evaporator 406 to be crystallized. After elution, the first anion exchange column 404 may be regenerated with a 1.04 N basic solution.

The partially deacidified cranberry juice and the quinic acid are then passed through a second anion exchange column 410 to be separated from one another. The second anion exchange column 410 has greater affinity for quinic acid than the first anion exchange column 404.

In the second anion exchange column 410, a partially deacidified cranberry juice solution is separated from quinic acid and salts, which are attracted to an anion exchange resin in the second anion exchange column 410. In some implementations, the second column is packed with WA 30 Resin from Itochu International Inc. WA 30 resin is a 70% weak base anion exchange resin with 30% strong base anion exchange capacity on a polystyrene, divinyl benzene matrix. In other implementations, A133S or A123S* resin from Purolite Corporation, Dowex Monosphere 77 resin from DOW Chemical, or Diaion WA30 or WA 55* from Itochu could also be used. Both WA 30 resin and A133S resins exhibit tertiary amine function and quaternary amine function.

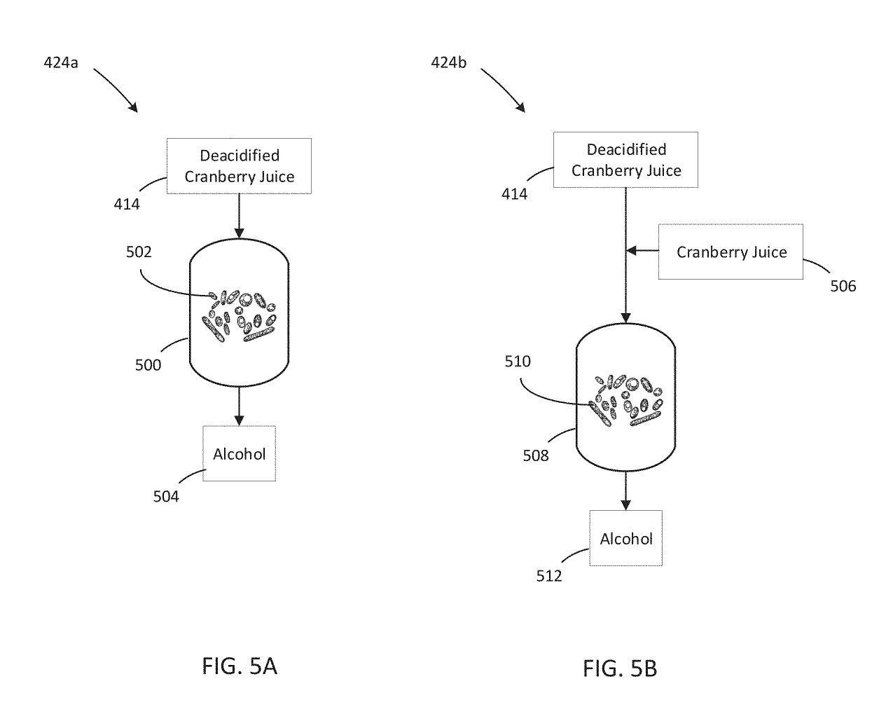

In the second anion exchange column, quinic acid and salts are adsorbed by the resin. With the quinic acid and salts being bound by the resin, a deacidified cranberry juice solution (i.e., low or no citric, malic, or quinic acid concentration in the solution) can be obtained. The deacidified cranberry juice solution flows through line 126 in FIG. 1A to be recycled back to the osmotic optimizer 102. The deacidified cranberry juice solution can be run through an evaporator 412 to produce an approximately 67° Brix deacidified cranberry juice solution 414. In the osmotic optimizer the deacidified juice can be blended back into the infusion/extraction syrup, to establish a fully recyclable loop of sugars. In other methods, the deacidified cranberry juice 414 can be used as a feedstock for a fermentation process 424 to produce alcohol, such as vodka or brandy, as will be discussed in relation to FIGS. 5A and 5B. The quinic acid and salts can be eluted with a 0.253 N basic solution. Following full elution, the second anion exchange column can be regenerated with a 1.04 N basic solution.

Upon separating out the deacidified cranberry juice 414, the quinic acid and salts are fed into a third exchange column 416 to be separated from one another. The third exchange column 416 may be a strong base anion exchange column or a cation exchange column. In some implementations, the third column includes FPA 98 resin from The Dow Chemical Company. FPA 98 resin is a strong base anion exchange resin on an acrylic gel matrix with quaternary amine function. In some implementations, the third exchange column 416 is a cation exchange column that exchanges sodium ions for hydrogen ions. Example resins that may be used include Monosphere 88H from DOW Chemical, PK216 H-form* and PK228 H-form* both from Itochu, and C145H* or C160H* from Purolite. In such implementations, a sodium quinate stream is flowed over the cation exchange resin and hydrogen ions are exchanged for sodium ions, resulting in an acidified quinic acid stream ready for crystallization

During operation of the third exchange column 416, a dilute mobile phase of hydrochloric acid is used. Quinic acid is retarded by its attraction to the resin while other impurities flow through faster, allowing for the collecting of a band of quinic acid. The resulting quinic acid solution may then be collected and concentrated to super saturation under vacuum or in any environment that ensures no loss via heat degradation or oxidation (e.g., by evaporator 418). Once supersaturated, the organic acid solutions can be seeded with high purity crystals and cooled to allow for ordered crystallization of the acid in crystallizer 420 to form purified quinic acid 422.

In some implementations, the process is performed at room temperature (approximately 20-25° C.). However, in some implementations, high temperature water (up to approximately 100° C.) may be used. Additionally, acids may be removed from other fruit juices or concentrates, including grape juice or wine, in addition to cranberry, in the same manner. Examples of other juices that may be deacidified using such a process include fruit juices, e.g., apple juice, orange juice, pineapple juice, mango juice, grape juice, guava juice, strawberry juice, banana juice, kiwi juice, watermelon juice, lemon juice, cherry juice, date juice, apricot juice, plum juice, prune juice, pear juice, passionfruit juice, peach juice, blueberry juice, elderberry juice, chokeberry juice, lingonberry juice, raspberry juice, gooseberry juice, huckleberry juice, blackberry juice, cloudberry juice, blackcurrant juice, redcurrant juice, white currant juice, pomegranate juice, lime juice and/or any mixture thereof. Other aqueous solutions, such as those created from spruce, cinchona bark, green and blue cured tobacco leaves, and green and roasted coffee beans, may be used.

For any acid-laden feedstock, insoluble solids can be removed before purification and extraction of acids. In some implementations, the process can be used to preferentially remove malic acid while leaving lactic acid behind in the solution. In some implementations, the process may separate out succinic acid, isocitric acid, or oxalic acid instead of or in addition to quinic acid. In some implementations, the first anion exchange column 404 may be replaced with a bipolar electrodialysis unit to separate malic and citric acids from the quinic acid and sugar solution.

In some implementations, the anion exchange may take place outside of a column, for example in a batch adsorption process. In such implementations, a given volume of fluid would be contacted with a specified depth or amount of resin within a vessel or bed. The amount of resin would be 4.0-6.0 g of resin for each gram of dissolved acid in the feedstock.

Referring to FIG. 5A, deacidified juice, such as cranberry juice 414 can be fermented into alcohol 504 by a fermentation process 424a. In an exemplary fermentation process 424a, deacidified cranberry juice 414 is introduced into a fermenter 500 with an active culture 502, which may be, for example, Saccharomyces Cerevisiae, Saccharomyces Bayanus, Saccharomyces Pastorianus, or Saccharomyces eubayanus. The deacidified cranberry juice 414 and the active culture 502 mixture has a dissolved solids content of approximately 8.0-30.0 degrees Brix and a pH of approximately 3.5 to 6.0. The mixture is exposed to a temperature of between approximately 5.0° C. and 40.0° C. in the fermenter for approximately 2 to 10 days. During fermentation, the mixture may or may not be agitated. After fermentation in the fermenter 500, the mixture can be treated, e.g., filtered and/or distilled to produce the alcohol 504. The alcohol may be, for example, vodka or brandy.

Referring to FIG. 5B, deacidified cranberry juice 414 can be fermented into alcohol 512 by a fermentation process 424b. In an exemplary fermentation process 424b, deacidified juice, such as deacidified cranberry juice 414 can be mixed with cranberry juice 506 (non-deacidified) and the mixture introduced into a fermenter 508 with an active culture 510, which may be for example Saccharomyces cerevisiae. Mixing the deacidified cranberry juice 414 with the non-deacidfed cranberry juice 506 lowers the pH of the solution for fermentation to between pH 3.5 and 6.0. It may be advantageous to mix the deacidified cranberry juice 414 with cranberry concentrate 506 to form a solution for fermentation with a pH corresponding to an optimal pH for the active culture 510 to inhabit and perform fermentation. After fermentation in the fermenter 508, the mixture can be filtered and/or distilled to produce the alcohol 512. The alcohol may be, for example, vodka or brandy.

In another fermentation implementation, deacidified cranberry juice is mixed with non-deacidified cranberry juice to form a mixture with a pH of greater than 2.5. An active culture is added and then the mixture is fermented, at a temperature of approximately 15-45° C., The active culture may be one or a combination of the following cultures: streptococcus thermophiles; bacillus laterosporus; pediococcus acidilactici; bifidobacterium breve; bifidobacterium infantis; bifidobacterium bifidum; bifidobacterium lactis; bifidobacterium longum; lactobacillus acidophilus; lactobacillus brevis; lactobacillus bulgaricus; lactobacillus casei; lactobacillus gasseri; lactococcus lactis; lactobacillus plantarum; lactobacillus paracasei; lactobacillus rhamnosus; lactobacillus salivarius. The fermentation adds healthful probiotic cell mass to the cranberry juice environment. Optionally, after successful fermentation, organic acids removed before the fermentation may be blended back as acid salts of magnesium, sodium, and potassium to produce a full strength cranberry cultured beverage.

Referring back to FIG. 1A, citric and malic acids are absorbed onto the resin as the filtered spent infusion/extraction syrup flows through the first anion exchange bed 118. With the citric and malic acids being bound by the resin, the bed 118 is rinsed with deionized water for characterization. During this characterization (or sweeten-off), partially deacidified filtered spent infusion/extraction syrup (i.e., filtered spent infusion/extraction syrup having reduced citric and/or malic acid content) and quinic acid are collected. The acids remaining in the first anion exchange bed 118 after the rinse (i.e., the citric and malic acids) are eluted from the bed 118 with sodium hydroxide or another basic solution at a concentration, for example, of 0.1 N to 1.0 N. The citric and malic acids are fed into line 120 and may optionally be fed into an evaporator (not shown) to be crystallized. Crystallized citric and malic acids may be, for example, added into beverages as acidulants, esterified into plasticizing molecules, and/or used as raw materials in pharmaceutical manufacturing. After elution, the first anion exchange bed 118 may optionally be regenerated with a 1.04 N basic solution.

In some implementations, the first anion exchange bed 118 may be replaced with an electrodialysis unit to remove citric and malic acids from the filtered spent infusion/extraction syrup.

Upon removal of the citric and malic acids from the filtered spent infusion/extraction syrup, partially deacidified and filtered spent infusion/extraction syrup in line 122 still contains quinic acid. The quinic acid can be separated from the sugars of the partially deacidified filtered spent infusion/extraction syrup in a second anion exchange bed 124. A second anion exchange resin in the second anion exchange bed 124 adsorbs the quinic acid and salts. With the quinic acid and salts being bound by the resin, a deacidified spent infusion/extraction syrup (i.e. no or low citric, malic, or quinic acids) can be obtained and fed into line 126. The deacidified spent infusion/extraction syrup may be a deacidified fruit or vegetable juice.

In some implementations, wherein higher quinic acid levels are desirable, a single chromatography solution may be used. In this implementation, spent infusion/extraction syrup may be fed to a column with high affinity to all three organic acids and the amount of quinic acid in the recycled syrup may be controlled by the total amount of spent syrup passed over the resin. For a syrup with 0.1% wt quinic acid or less, the number of bed volumes would be 3 or less while for a product with a 0.5% wt quinic acid or greater the bed volumes fed would be 8 or greater.

The quinic acid and salts can be eluted, e.g., with a 0.25 N basic solution and fed into line 128. From line 128, the quinic acid may be purified and crystallized to be used commercially. For example, the purified quinic acid can be a raw material for pharmaceuticals and/or natural flavors or can be first esterified with methanol/ethanol and then transesterified with a long chain fatty alcohol C10/C12 to form a non-ionic surfactant. Following full elution, the second anion exchange bed 124 can be regenerated with 1.04 N basic solution.

### Evaporation and Mixing

Referring to FIG. 1A, the deacidified spent infusion/extraction syrup in line 126 can be mixed with the ultrafiltration retentate in line 114 in mixing tank 130. The retentate contains long chain molecules that may include PACs, other phenolics, glucans, dextrins, and soluble fibers. The deacidified spent infusion/extraction syrup contains sugars. The deacidified spent infusion/extraction syrup and long chain molecule mixture from holding tank 130 is fed through line 132 into an evaporator 134. In evaporator 134, the deacidified spent infusion/extraction syrup and long chain molecule mixture is heated to reduce the water content of the mixture. For example, the deacidified spent syrup and long chain molecule mixture may be approximately 10-20° Brix upon entering evaporator 134, and evaporator 134 may increase the solids content of the mixture to approximately 45-60° Brix.

After evaporation, the concentrated mixture exits through line 136. Bulking agents, such as glucose, fructose, sucrose, sugar alcohols, maltodextrins and other dextrins and glucans, fructans and soluble fibers, and/or amino acids, peptides and partially hydrolyzed proteins of less than 10,000 Daltons, exit holding tanks 146 and 148 through lines 140 and 150, respectively. For example, soluble fiber is contained in tank 146 and a cranberry concentrate (including glucose and fructose) is contained in tank 148. The concentrated mixture from the evaporator 134, the soluble fiber in tank 146, and the cranberry concentrate in tank 148 can be fed through lines 136, 140, and 150 respectively, to a proportional feeder 152. The proportional feeder 152 balances these three streams to provide the necessary water, solids, and bulking agent concentrations to the blend tank 138 through line 154. A recycled infusion/extraction syrup is formed from the bulking agents and concentrated mixture that are mixed in the blend tank 138. The bulking agents may be introduced in varying concentrations and combinations based on the fruit to be infused and extracted. For example, for cranberries, the recycled infusion/extraction syrup can be at least 1% fructose and at least 4% glucose based on the sugar concentrations of cranberries. Therefore, in one implementation, the infusion/extraction syrup may consist of only the sugars typically present in the fruit (e.g., approximately 1% fructose and approximately 4% glucose for cranberries). In this example, the infusion/extraction syrup will behave only as extraction syrup. In another implementation, other bulking agents may be used in order for the bulking agents to be infused into the cranberries. Other bulking agents, including sucrose, maltodextrins, amino acids, peptides, partially hydrolyzed proteins of less than 10,000 Daltons, and soluble fiber may make up between 0% and approximately 60% of the recycled infusion/extraction syrup.

Soluble fibers to be used as bulking agents may be converted from insoluble biomass derived from fruit. The fruit used to produce the soluble fibers may be of the same or a different fruit type as the fruit that is infused and extracted in the optimizer 102. Generally, the methods include a step of treating a cellulosic material (from fruit) with high pressure (greater than 50 psi) and temperature (greater than 150° C.) water. The water used in the methods has a pH of approximately 6 to 8. In some instances, amphiphilic molecules, such as emulsifiers, may also be included. Amphiphilic molecules have both polar (water-soluble) and non-polar (not water-soluble) portions in their structures. As such, the introduction of amphiphilic molecules helps to disrupt hydrophobic interactions between cellulose molecules within inter sheet spaces. This allows water to get into the inter sheet spaces and eventually disrupt the crystalline structure of cellulose. Examples of amphiphilic materials include, but are not limited to, Poly Ethylene Glycols (PEG) and their derivatives, Phospholipids, including lecithin, Glycolipids, Urea or Thiourea, Salts of Fatty Acids, Sodium Dodecyl Sulfate, N-Methylmorpholine N-oxide (NMMO), alcohol alkoxylates, alkyl amine ethoxylates, alkyl phenol ethoxylates, oil based or fatty acid or sorbitan ethoxylates, polyalkene oxide copolymers, alkyl benzene sulfonates, alkyl naphthalene sulfonates, alkyl sulfonates, fatty acid sulfonates, lingo sulfonates and dioctyle sulfosuccinates, or any combinations thereof. Not all of these amphiphilic molecules could be used for converting soluble fiber that would be used in a food product, however, they may be suitable for non-food product applications, including production of bio-fuels.

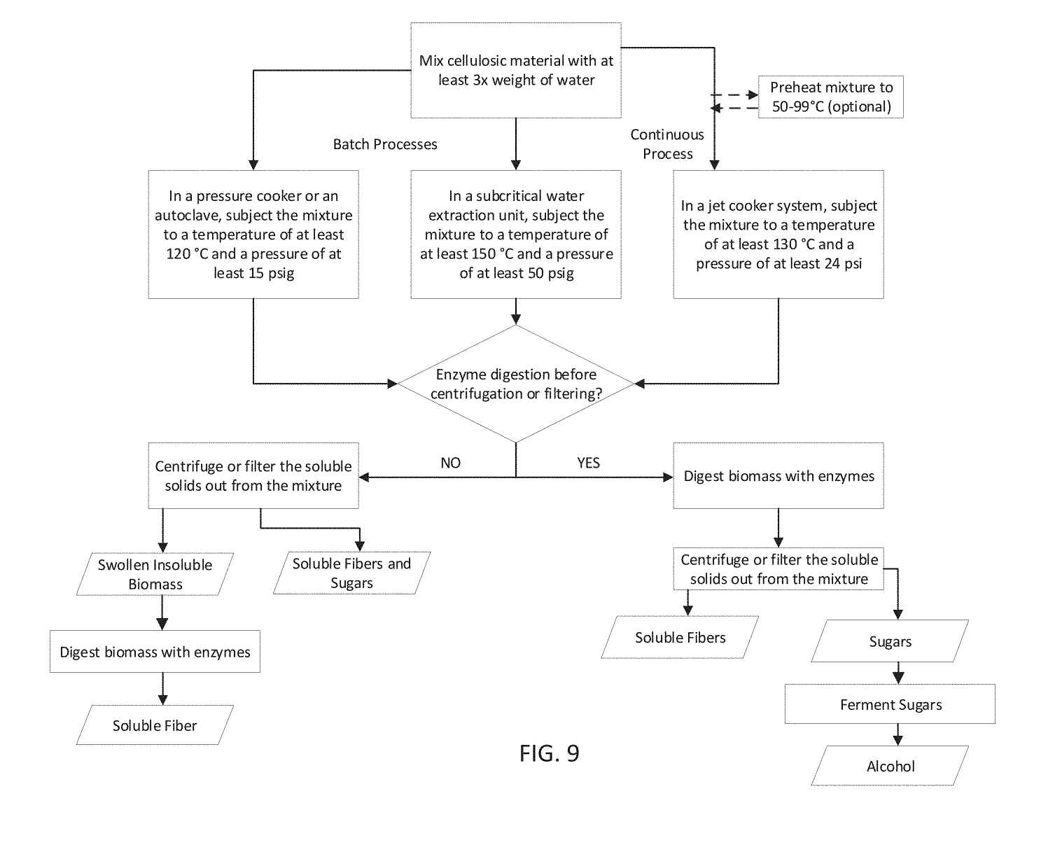

Referring to FIG. 9, a batch process or a continuous process (or a combination of the two) may be used to convert insoluble fibers in the cellulosic biomass material to soluble fibers. In exemplary batch processes, a pressure cooker, an autoclave, or a subcritical water extraction unit may be used to deliver the high pressure and temperature required. In a batch process, the cellulosic biomass material may be mixed with, for example, at least three times its weight in water. For a subcritical water extraction, after mixing, the temperature and pressure of the mixture is raised to at least 150° C. and at least 50 psig. In some implementations, the temperature is raised to between 150° C. and 160° C. In some implementations, the temperature is raised to between 160° C. and 170° C. In some implementations, the temperature is raised to between 170° C. and 180° C. In some implementations, the temperature is raised to between 180° C. and 190° C. In some implementations, the temperature is raised to between 190° C. and 200° C. In some implementations, the pressure is raised to between 50 psig and 100 psig. In some implementations, the pressure is raised to between 100 psig and 150 psig. In some implementations, the pressure is raised to between 150 psig and 200 psig. In some implementations, the pressure is raised to between 200 psig and 250 psig. In some implementations, the pressure is raised to between 250 psig and 500 psig. In some implementations, the pressure is raised to between 500 psig and 1000 psig. In some implementations, the pressure is raised to between 1000 psig and 1500 psig. In some implementations, the pressure is raised to between 1500 psig and 2000 psig. In some implementations, the pressure is raised to between 2000 psig and 3000 psig.

The high temperature and pressure are maintained for a period of approximately 3 to 15 minutes, for example, about 3 minutes to about 5 minutes, about 3 minutes to about 10 minutes, about 5 minutes to about 10 minutes, about 5 minutes to about 15 minutes, about 10 minutes to about 15 minutes, or about 3 minutes, about 5 minutes, about 10 minutes, or about 15 minutes, during which the conversion of insoluble solids in the cellulosic biomass material to soluble solids occurs. In some implementations, the pressure can be released and the mixture cooled to between 4° C. and 50° C., for example about 4° C. to about 10° C., about 4° C. to about 20° C., about 4° C. to about 30° C., about 4° C. to about 40° C., about 10° C. to about 20° C., about 10° C. to about 30° C., about 10° C. to about 40° C., about 10° C. to about 50° C., about 20° C. to about 30° C., about 20° C. to about 40° C., about 20° C. to about 50° C., about 30° C. to about 40° C., about 30° C. to about 50° C., about 40° C. to about 50° C., or about 4° C., about 10° C., about 20° C., about 30° C., about 40° C., or about 50° C.

In some implementations, the mixture of water and cellulosic biomass material is passed through a direct steam injection system. The steam pressure in the direct steam injection system is at least approximately 90 psig. The direct steam injection system heats the mixture to at least 130° C. and has a back pressure of at least 24 psig. The upper limits of the steam pressure and the back pressure are limited by the availability of the system. The steam pressure may be as high as 200 psig and the back pressure may be as high as 130 psig.

In an exemplary continuous process, the cellulosic biomass material can be mixed with at least four times its weight in water. After mixing, the mixture may optionally be preheated to approximately 50° C. to 99° C. For continuous processes, a jet cooking system, such a Pick™ Direct Steam Injection Heater, can be used to deliver the required high pressure and temperature. The mixture is passed through a direct steam injection system, such as a jet cooker, and the temperature is raised to at least 130° C. and the product pressure is raised to at least 24 psig. In some implementations, the temperature is raised to between 130° C. and 140° C. In some implementations, the temperature is raised to between 140° C. and 150° C. In some implementations, the temperature is raised to between 150° C. and 160° C. In some implementations, the temperature is raised to between 160° C. and 170° C. In some implementations, the temperature is raised to between 170° C. and 180° C. In some implementations, the pressure is raised to between 24 psig and 50 psig. In some implementations, the pressure is raised to between 50 psig and 100 psig. In some implementations, the pressure is raised to between 100 psig and 130 psig. Excess water is flashed off as the pressure is reduced back to atmospheric pressure, which is approximately 14.7 psi. In some implementations, a series of jet cookers may be used. The collected mixture is optionally cooled, for example to between 4° C. and 50° C., and then centrifuged and/or filtered to remove the insoluble material still present in the mixture.

After either a batch process or a continuous process is used to convert the insoluble solids to soluble solids, the resultant mixture may be filtered or centrifuged to separate out any remaining insoluble solids. In some implementations, an enzyme digestion step is performed before centrifugation or filtering. Any type of filtration apparatus may be used, however a filtration system under vacuum reduces the filtration time significantly. Centrifugation may be carried out at between 1,000 and 15,000 RPM for approximately 5-30 minutes. In some implementations, the insoluble solids may be rinsed or washed at least once to remove any remaining soluble solids that may be trapped inside a matrix of insoluble solids. The wash or rinse liquid may be added to the filtrate (if a filtration process was used) or supernatant (if a centrifugation process was used) that contains soluble solids.

In some examples, the still insoluble portion (e.g. a swollen insoluble biomass) may be treated with enzymes, such as cellulases to create more soluble fibers. The enzyme treated mixture is heated to deactivate the enzymes. The resultant mixture then may be filtered or centrifuged again to separate out any remaining insoluble solids. The supernatant or the filtrate may be added back to the previously created filtrate and/or supernatant containing previously created soluble solids.

In another example, the resulting soluble solids may be treated with enzymes or subjected to fermentation to further convert the soluble solids to sugars, alcohols, or small chain fatty acids. Cellulases, hemicellulases, arabinase, xylanases, β-glucosidases may be used to convert soluble fibers to mono and di-saccharides. Furthermore, these sugars may be fermented to produce alcohols. While fermentation parameters vary heavily depending on the type of yeast used, typically fermentation of simple sugars produced via cellulosic digestion with Saccharomyces Cerevisiae to produce ethyl alcohol can occur at a pH of approximately 3.0-6.0, a solids content of approximately 6% to 30% and a temperature of between approximately 5° C. and 40° C. In some examples, fermentation may take place at a pH of about 3.0 to about 4.0, about 3.0 to about 5.0, about 4.0 to about 5.0, about 4.0 to about 6.0, about 5.0 to about 6.0, or about 3.0, about 4.0, about 5.0, or about 6.0. In some examples, the solids content of the fermentable mixture is about 6% to about 10%, about 6% to about 20%, about 6% to about 30%, about 10% to about 20%, about 10% to about 30%, about 20% to about 30%, or about 6%, about 10%, about 20%, or about 30%. In some examples, a fermentation process may take place at about 5° C. to about 10° C., about 5° C. to about 20° C., about 5° C. to about 30° C., about 5° C. to about 40° C., about 10° C. to about 20° C., about 10° C. to about 30° C., about 10° C. to about 40° C., about 20° C. to about 30° C., about 20° C. to about 40° C., about 30° C. to about 40° C., or about 5° C., about 10° C., about 20° C., about 30° C., or about 40° C.

In another example, whole fruit, in addition to or instead of, cellulosic biomaterial from presscake or pomace may be used as a starting material. In an exemplary batch processes, a pressure cooker, an autoclave, or a subcritical water extraction unit may be used to deliver the high pressure and temperature required. In a batch process, the cellulosic biomass material may be mixed with, for example, at least three times its weight in water. After mixing, the temperature and pressure of the mixture is raised to at least 150° C. and at least 50 psig. The high temperature and pressure are maintained for a period of approximately 3 to 15 minutes, during which most of the insoluble solids present in the fruit will be converted to soluble solids. In some implementations, the pressure can be released and the mixture cooled to between 4° C. and 50° C. The resultant mixture contains the extracted juice, high in phenolics, PACs and soluble fiber. The resultant mixture may be filtered or centrifuged to separate out any remaining insoluble solids.

The remaining unextracted but swollen cellulosic biomaterial may be further converted to soluble fiber using enzymes, such as cellulases to create more soluble fibers. The enzyme treated mixture is heated to deactivate the enzymes. The resultant mixture then may be filtered or centrifuged again to separate out any remaining insoluble solids. The supernatant or the filtrate may be added back to the previously created filtrate and/or supernatant containing previously created soluble solids.

In some examples, the soluble solids may be included as additives in food or beverage products. In other examples, the sugars, alcohols, or small chain fatty acids may be used as additives in food or beverage products. A food or beverage product may be, for example, a juice, an alcoholic drink, a dried fruit product, an infused fruit product, etc.

Referring back to FIG. 1A, the recycled infusion/extraction syrup can be fed by line 142 into a holding tank 144 before being introduced into line 104 for delivery to the optimizer 102. Alternatively, skilled practitioners will appreciate that the recycled infusion syrup can be fed directly from blend tank 138 into optimizer 102, e.g., bypassing the need for holding tank 144.

### Infusion of Large Molecules

In some implementations, large molecules such as proteins, partially hydrolyzed proteins, and/or long chain carbohydrates (such as pectin) may interfere with the ultrafiltration and acid removal via resin separation processes as previously described. For example, these large molecules, which are typically greater than 5000 Daltons, may foul an ultrafiltration membrane or resin column.

As shown in an example system in FIG. 1B, in order to infuse these large molecules into the fruit, a second optimizer 150 may be used in series with the first optimizer 102. Flow of syrup and other liquids are shown in solid lines and flow of the fruit is shown in dot-dash lines. Water may enter the system 1000 at point 168 and evaporated at evaporators 164. If a second optimizer 150 is used, the first optimizer 102 and the second optimizer 150 are placed in two separate fluid loops such that no fluid from the second optimizer 150 will travel back to the first optimizer 102.

In the implementation shown in FIG. 1B, the large molecule infusion loop including second optimizer 150, which starts at a suspension tank 158 (which receives spent infusion/extraction syrup from line 110 and infused/extracted fruit through line 170 from the first optimizer 102), is physically separated from a main infusion/extraction loop including the first optimizer 102. The fruit flows through both optimizers 102, 150 such that the fruit contacts the infusion/extraction syrup (mixed in tank 144 as a combination of sugars and other bulking agents (at lower than a final desired Brix level, e.g., about 40° Brix) from tank 166 and recycled, deacidified syrup flowing from evaporator 134) in optimizer 102 and a second infusion syrup in the second optimizer 150. The fruit enters the optimizer 102 through line 106 and exits the optimizer 102 through line 170 and enters a surge tank 158. From the surge tank 158, the fruit flows into the second optimizer 150 through line 172. In the second optimizer, the fruit contacts the second infusion syrup from tank 180 that contains not only the same concentration of sugars and bulking agent as in the infused fruit in line 172, but also added large molecules. The desired concentration of large molecules in tank 180 is maintained via a proportional feeder that feeds the tank from large molecule tank 182. Skilled practitioners will appreciate that a solids content of the second infusion syrup in tank 180 is higher than a solids content of the first infusion syrup in tank 144. The fruit in the second optimizer 150 is infused with large molecules while limited or no other exchange of chemical components, other than water, takes place. The fruit including large molecules exits the second optimizer through line 174, passes through suspension tank 162, and exits the system 1000 through line 176, where the fruit may be dried and optional topical treatments may be performed.

The second infusion syrup, made in syrup tank 180 from a combination of a syrup from a surge tank 158, a large molecule solution from large molecule tank 182, and a solution from suspension tank 162, is used in the second optimizer 150. This second infusion syrup has the same composition as the syrup used in the surge tank 158 with the exception of the added large molecules (from tank 182 and suspension tank 162), promoting infusion of the large molecules without extraction of any of the other molecules already infused in the first optimizer 102. The syrup from the surge tank 158 and a spent syrup from the second optimizer 150 are flowed to the syrup tank 180 where the large molecules are added from large molecule tank 182. The large molecules tend to increase the viscosity of the infusion syrup. In order to improve the syrup flow, the syrup may be optionally heated to a temperature of about 140° F. The syrup containing large molecules may also be infused, in the second optimizer, under pressure between about 0 and about 100 MPa, or vacuum between about 0 and 20 in Hg. Skilled practitioners will appreciate that many peptides and carbohydrates are not one single molecule, but rather are a collection of molecules with a range of sizes. Moreover, some linear small peptides and carbohydrates with lower than 5,000 Dalton molecular weight may have a tendency to foul the ultrafiltration unit 112 and may need to be infused in the second optimizer 150. Therefore, the use of the second optimizer 150 is mostly dependent on the tendency of the infusion molecule to foul the ultrafiltration unit 112 rather than the size of the molecules.

### Topical Addition of Flavors

In some implementations the dried fruit product produced by this process may be flavored or modified by the topical addition of crystalline sugar (fructose, dextrose, sucrose, maltodextrins) or organic acids (quinic, malic, citric, and mixtures thereof), and/or an oil such as sunflower seed oil or cranberry seed oil enriched in or containing non-polar target molecules, including, but not limited to, tocopherols (alpha, beta, gamma, and/or delta isomers), tocotrienols (alpha, beta, gamma, and/or delta isomers), omega-3 fatty acids such as alpha linoleic acid, etc. These target molecules for infusion will have a carbon to oxygen ratio ranging from 18:2 to 28:2 and degrees of unsaturation ranging from 4 to 9.

### Transfer Between System Processes

The system 100 described herein is described as having “lines” connecting various components of the system. Lines may include pipes, tubing, and/or conveyor systems. Skilled practitioners will appreciate that in some configurations, line(s) may be eliminated entirely, opting instead for direct connection between any two or more modules of the system. In some implementations, all components of the system can be connected and the system can be a continuous processing system. In other implementations, some or all of the lines may be replaced with batch transport, e.g. transporting material from one component to another in barrels or other containers.

A number of implementations of the invention have been described. Nevertheless, it will be understood that various modifications may be made without departing from the spirit and scope of the invention. Accordingly, other implementations are within the scope of the following claims.

### EXAMPLES

### Acid Removal Examples

The following description and corresponding chromatograms and mass balances demonstrate the fractionation of organic acids from cranberry juice concentrate and should be applicable to similar fruit source materials. During the course of the chromatography, the naturally occurring pigment molecules in cranberries are used as an indicator of eluent pH and acid content. At pH greater than 7.5, the acid content is less than 0.5% wt and the color of natural pigments is greenish yellow. At bed exhaustion and acid leakage, the pigment returns to its characteristic red color as the pH falls to 2.0-4.5.

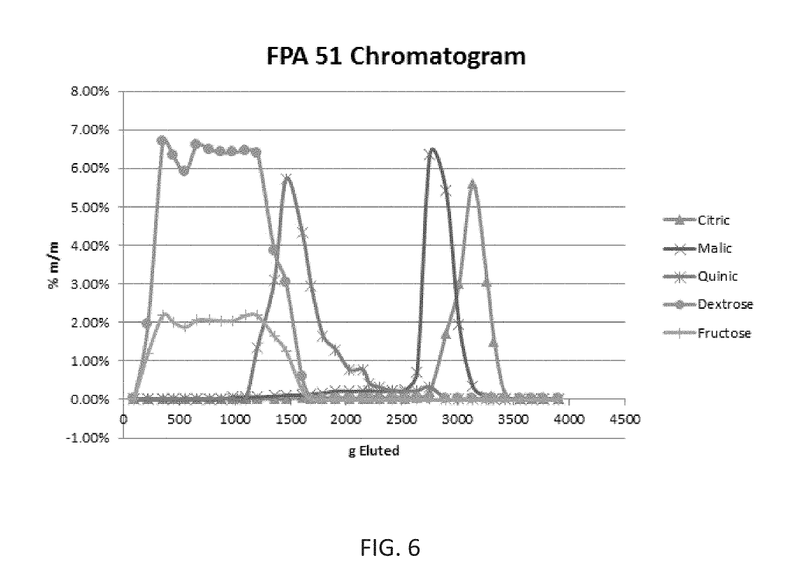

FIG. 6 is a chromatogram showing concentrations of stream components after running through a first column of the system 400 of FIG. 4. In this example, cranberry concentrate created from a countercurrent extraction method was fed to a column of FPA 51 Resin manufactured by DOW. The resin is a macroporous polystyrene based resin with divinyl benzene co-polymers to give the resin better structural durability. The active group that is attached to styrene monomers is a tertiary alkyl amine. Examples of ion exchange resins that may be used include DOWEX Monosphere 77 and Purolite A111S. Cranberry concentrate is fed at 2.5 bed volumes per hour (BV/hr) for 3 BV. The column has a depth of 1.20 meters. Once the column has adsorbed all of the organic acid it can (i.e. when the column is exhausted), the column is rinsed with deionized water at a rate of 2.5 BV/hr for 2 BVs. Malic and citric acids are then eluted using a 1.0% wt NaOH solution fed at 1.5 BV/hr at a usage rate of 12 g NaOH per L of resin. Once the elution has finished, the column is regenerated using 4.0% wt NaOH solution fed at 1.5 BV/hr at a usage rate of 70 g NaOH per L of resin. The column is then rinsed once more and equilibrated before more concentrate is again fed. At larger scale a system of such columns run in parallel would be assembled to mimic a continuous fed process. The operating parameters of the FPA column and an example mass balance are summarized below in Tables 1 and 2. Note that sodium and phenolics are not included in the mass balance.

TABLE 1
FPA 51 Column Operating Parameters.

| Operating Parameter | Value |
|---|---|
| Concentrate sugar content | 15.03 Brix |
| Column depth | 1.0-1.2 meters |
| Feed rate | 2.5 bed volumes (BV) per hour |
| Exhaustion | 3 BV |
| Rinse | 2 BV with deionized water at 2.5 BV/hr |
| Elution | 1.0% NaOH at 1.5 BV/hr for 12 g NaOH |
| | per L of resin |
| Regeneration | 4.0% NaOH at 1.5 BV/hr for 70 g NaOH |
| | per L of resin |

TABLE 2
Example Mass Balance for FPA 51 Column.

| | g Dextrose | g Fructose | g Quinic | g Malic | g Citric |
|---|---|---|---|---|---|
| IN | 74.84 | 28.07 | 23.58 | 18.34 | 23.58 |
| OUT Deacidified | 75.30 | 28.87 | 26.70 | 2.32 | 0.22 |
| Juice | | | | | |
| OUT Acids | 0 | 0 | 0.83 | 19.07 | 18.17 |

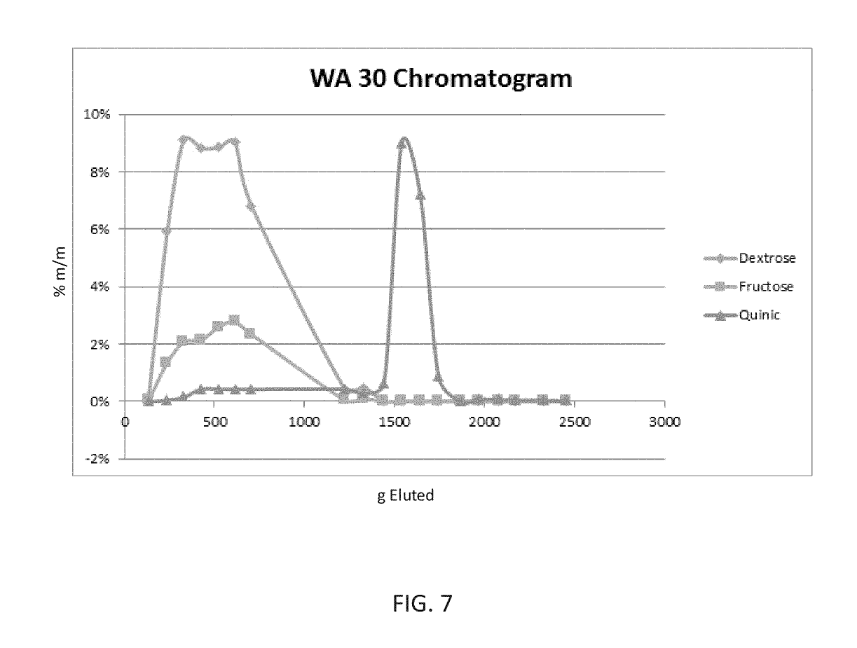

Referring to FIG. 7 is a chromatogram showing concentrations of stream components after running through a second column of the system 400 of FIG. 4. The second column is packed with WA 30 Resin from Itochu. WA 30 resin is a 70% weak base anion exchange resin with 30% strong base anion exchange capacity on a polystyrene, divinyl benzene matrix. A133S resin from Purolite could also be used. These resins exhibit both tertiary amine function and quaternary amine function. In the WA 30 column, the quinic acid rich portion of the previous example is fed to a column of 0.6 m depth at a feed rate of 3.0 bed volumes per hour for two bed volumes before exhaustion. The column is then characterized and quinic acid eluted with 1.0% wt NaOH solution. Following full elution the column is regenerated with 4.0% wt NaOH solution. The operating parameters of the WA 30 column and an example mass balance are summarized below in Tables 3 and 4. Note that sodium and phenolics are not included in the mass balance.

TABLE 3
WA 30 Column Operating Parameters.

| Operating Parameter | Value |
|---|---|
| Feed | Deacidified eluent from FPA 51 at 12.0 |
| | Brix |
| Column depth | 0.6 meters |
| Feed rate | 3.0 BV/hr |
| Exhaustion | 2 BV |
| Rinse | 1 BV with deionized water at 2.5 BV/hr |
| Elution | 1.0% NaOH at 1.5 BV/hr for 12 g NaOH |
| | per L of resin |
| Regeneration | 4.0% NaOH at 1.5 BV/hr for 70 g NaOH |
| | per L of resin |

TABLE 4
Example Mass Balance for WA 30 Column.

| — | g Dextrose | g Fructose | g Citric | g Malic | g Quinic |
|---|---|---|---|---|---|
| IN | 60.75 | 23.29 | 0.00 | 1.87 | 21.54 |
| Out-Cranberry | 49.16 | 13.03 | 0.52 | 0.96 | 4.54 |
| Sugar | | | | | |
| Out-Acid | 0.00 | 0.00 | 0.00 | 0.91 | 18.34 |

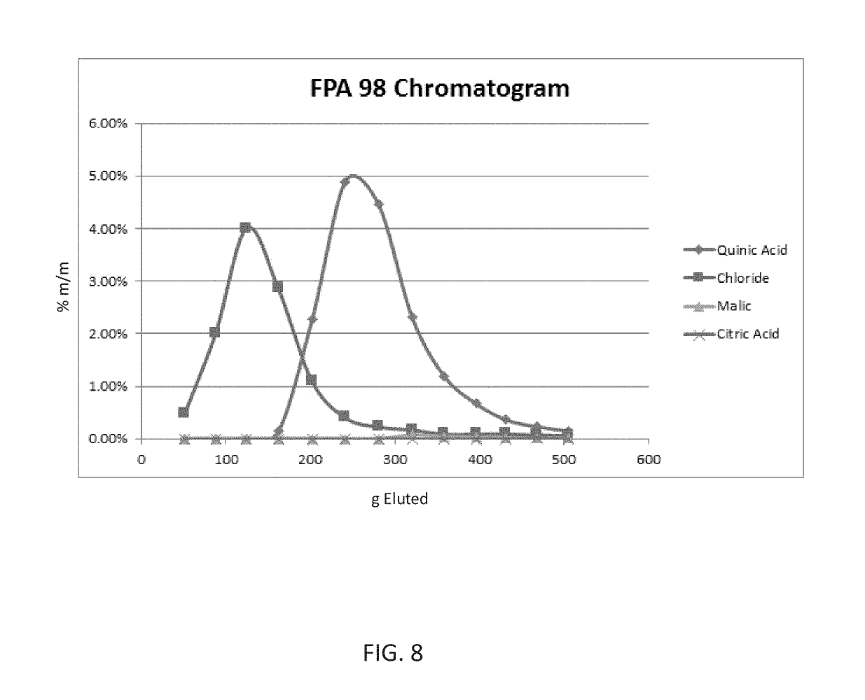

Referring to FIG. 8 is a chromatogram showing concentrations of stream components after running through a third column of the system 400 of FIG. 4. The third column includes FPA 98 resin. FPA 98 resin is a strong base anion exchange resin on an acrylic gel matrix with quaternary amine function. Between the WA 30 column and the FPA 98 column the sample was treated with powdered activated carbon at a use level of 12 g carbon per Liter of acid rich fraction to remove phenolic compounds. The activated carbon was Cabot KB WJ Supra, however many activated carbons would also be suitable to use. The quinic acid rich solution from WA 30 was carbon treated then injected into the FPA 98 column and carried through the column with a mobile phase of 0.01M HCl moving at 2.0 BV/hr. Two fractions were collected, an acid rich and salt rich fraction, tabulated below. The operating parameters of the FPA 98 column and an example mass balance are summarized below in Tables 5 and 6.

TABLE 5
FPA 98 Column Operating Parameters.

| Operating Parameter | Value |
|---|---|
| Feed | Quinic acid and sodium solution from |
| | WA 30 column |
| Column depth | 0.6 meters |
| Injection | 10% BV injection at 10% wt dissolved |
| | solids |
| Mobile Phase | 0.01M HCl at 2.0 BV/hr |

TABLE 6
Example Mass Balance for FPA 98 Column.

| | | | | g Sodium |
|---|---|---|---|---|
| — | g Citric Acid | g Malic Acid | g Quinic Acid | Chloride |
| Inlet (including | 0.00 | 0.10 | 6.61 | 4.51 |
| Mobile Phase) | | | | |
| Salt Fraction | 0.00 | 0.00 | 0.96 | 3.97 |
| Quinic Fraction | 0.00 | 0.08 | 5.57 | 0.49 |

The third exchange column 416 shown in FIG. 4, may be a cation exchange column. The cation exchange column exchanges sodium ions for hydrogen ions. Example resins that may be used include Monosphere 88H from DOW Chemical, PK216 H-form* and PK228 H-form* both from Itochu, and C145H* or C160H* from Purolite. An example mass balance for a cation exchange column is shown below in Table 7. The exiting solution from the cation exchange column that is rich in quinic acid was crystallized at a purity of 98.92% m/m quinic acid.

TABLE 7
Example Mass Balance for Cation Exchange Column.

| | g Quinic Acid | g Other Solids |
|---|---|---|
| IN | 11.83 | 6.493740199 |
| OUT (product) | 12.04 | 1.323324199 |

### Soluble Fiber Conversion Examples

### Example 1

### Pressure Cooker Treatment of Cellulosic Biomass Material

In an example batch procedure for converting insoluble solids from cellulosic biomass material into soluble solids, lignocellulosic biomass material from cranberries was used. The lignocellulosic biomass material was subjected to a temperature of 120° C. and a pressure of 15 psi in a pressure cooker for a time of 10 minutes. The yield of soluble solids as a percentage of the lignocellulosic pulp used in the process was between approximately 20% and 30%. This yield is presented in FIG. 2 alongside the yields of the two subsequent examples, Examples 2 and 3.

### Example 2

### Jet Cooker Treatment of Cellulosic Biomass Material

In an example continuous procedure for converting insoluble solids from cellulosic biomass material into soluble solids, lignocellulosic biomass material from cranberries was used. The lignocellulosic biomass material was subjected to a temperature of 160° C. and a pressure of 80 psi in a jet cooker for a few seconds. A few seconds may be for example, a time between 1 and 10 seconds. The yield of soluble solids as a percentage of the lignocellulosic pulp used in the process was between approximately 40% and 50%.

### Example 3

### Subcritical Water Treatment of Cellulosic Biomass Material

In another example batch procedure for converting insoluble solids from cellulosic biomass material into soluble solids, lignocellulosic biomass material from cranberries was used. The lignocellulosic biomass material was subjected to a temperature of 160° C. and a pressure of 2000 psi in a subcritical water extraction unit for three cycles, each 3 minutes in duration. The yield of soluble solids as a percentage of the lignocellulosic pulp used in the process was between approximately 60% and 65%.

### Example 4

### Further Digestion of Insoluble and Soluble Solids to Sugars

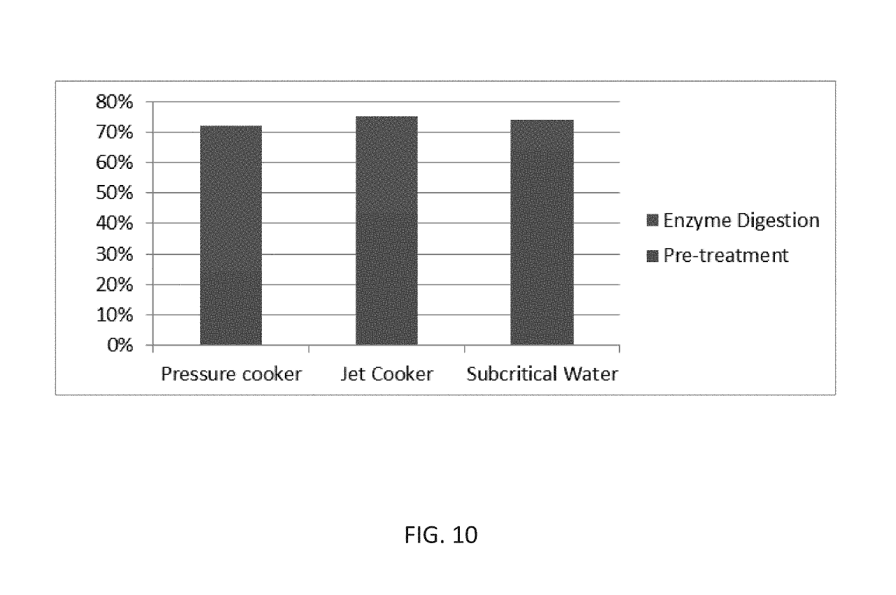

In exemplary enzyme digestion processes, soluble fibers removed from cranberry lignocellulosic biomass material by any of the examples above may be converted to sugars. Excess enzymes, which were a combination of Sumizyme PX, Sumizyme ARS, Sumizyme C-G, and Sumizyme X (all manufactured by Shin Nihon Chemical Company, Ltd) were added to the already treated biomass from each of the three examples discussed above to observe further yield improvement and further digestion of the soluble solids. The treated biomass was incubated at 54.4° C. for 14-16 hours in order to allow enough time to complete the enzyme digestion. The digested mixture was then heated to 90° C. to ensure inactivation of the enzymes. FIG. 10 shows that no matter what pre-treatment was used as described in the above examples, the total yield was about the same, between approximately 70% and 80%. Further yield improvement of only 4-10% was achieved after enzyme digestion of the biomass treated with subcritical water (as discussed above in Example 3). In a control sample of soluble solids removed via subcritical water extraction (SWE (no enzyme)) the ratio of sugar to cellodextrin was approximately 0.6, which means there were less than 40% sugars in the recovered soluble solids treated with subcritical water extraction.

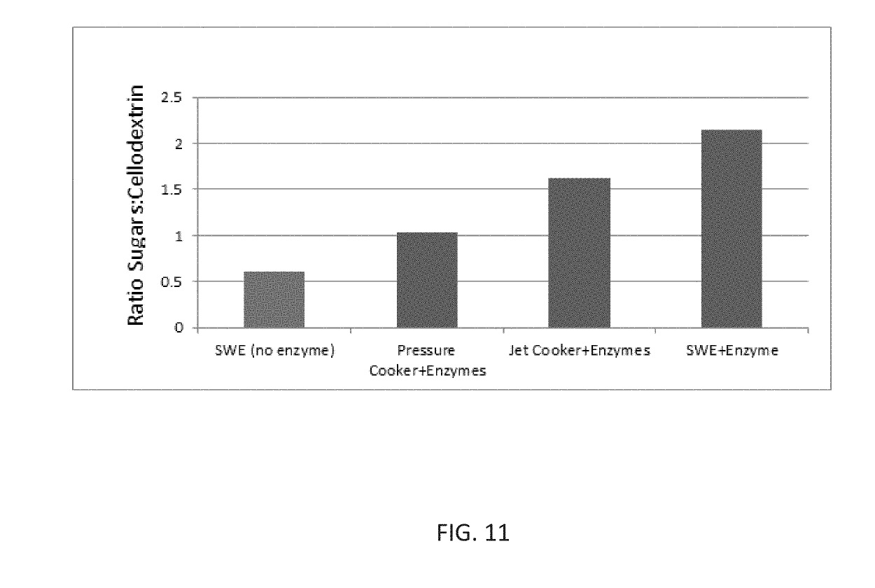

The resulting ratio of sugar to soluble fiber for the control sample and the enzyme-digested samples are shown in FIG. 11. The soluble solids removed via the pressure cooker batch process described in Example 1 above, when digested with the enzyme, yielded a sugar to cellodextrin ratio of approximately 1. The soluble solids removed via the jet cooker continuous process described in Example 2 above, when digested with the enzyme, yielded a sugar to cellodextrin ratio of approximately 1.63, approximately 62% sugars. The soluble solids removed via the subcritical water extraction batch process described in Example 3 above, when digested with the enzyme, yielded a sugar to cellodextrin ratio of approximately 2.14, approximately 68% sugars. A process may be selected depending on the desired ratio of sugars to fibers.

What is claimed is:

1. A method of processing a fruit or vegetable, comprising:
contacting a fruit or vegetable in an optimizer with a first deacidified juice, the first deacidified juice comprising at least one bulking agent and a sugar concentration that is at least about equal to the sugar concentration in the fruit or vegetable, under conditions sufficient to transfer acids from the fruit or vegetable to the first deacidified juice and bulking agent from the first deacidified juice to the fruit or vegetable, thereby producing an acidified juice and an infused fruit or vegetable product;
removing acids from the acidified juice to produce a second deacidified juice;
mixing the second deacidified juice with at least one bulking agent; and, optionally,
recycling the second deacidified juice comprising at least one bulking agent to the optimizer.

2. The method of claim 1, wherein the second deacidified juice comprising at least one bulking agent is recycled to the optimizer, and further comprising contacting a fruit or vegetable in the optimizer with the second deacidified juice.

3. The method of claim 2, wherein the fruit or vegetable in the optimizer is contacted with the second deacidified juice comprising at least one bulking agent under conditions sufficient to transfer acids from the fruit or vegetable to the second deacidified juice and bulking agent from the second deacidified juice to the fruit or vegetable.

4. The method of claim 1, wherein the optimizer is a countercurrent exchange device.

5. The method of claim 1, wherein the fruit or vegetable in the optimizer is a sliced, scarified, pitted, and/or pierced fruit or vegetable.

6. The method of claim 1, wherein the first deacidified juice comprises juice derived from the same type of fruit or vegetable as that in the optimizer.

7. The method of claim 1, wherein the first deacidified juice comprises juice derived from a fruit or vegetable that is of a type different from that in the optimizer.

8. The method of claim 1, wherein the fruit or vegetable in the optimizer is a fruit, and the fruit is a cranberry.

9. The method of claim 8, wherein the acidified juice comprises proanthocyanidins and phenolics removed from the fruit or vegetable in the optimizer.

10. The method of claim 9, further comprising removing proanthocyanidins and phenolics from the acidified juice via ultrafiltration before removing acids from the acidified juice.

11. The method of claim 10, further comprising mixing the proanthocyanidins and phenolics removed from the acidified juice with the second deacidified juice.

12. The method of claim 1, wherein removing acids from the acidified juice comprises removing malic acid or citric acid, or both.

13. The method of claim 1, wherein removing acids from the acidified juice comprises removing quinic acid.

14. The method of claim 1, wherein removing acids from the acidified juice comprises first removing malic and citric acids from the acidified juice by contacting the acidified juice with a first anion exchange resin and subsequently removing quinic acid from the acidified juice by contacting the acidified juice with a second anion exchange resin.

15. The method of claim 14, further comprising regenerating the first anion exchange resin and the second anion exchange resin with at least one of a phosphoric acid rinse or a deionized water rinse.

16. The method of claim 1, wherein removing acids from the acidified juice comprises treating the acidified juice in a bipolar electrodialysis unit.

17. The method of claim 1, wherein removing acids from the acidified juice comprises a combination of contacting the acidified juice with anion exchange resins and treating the acidified juice in a bipolar electrodialysis unit.

18. The method of claim 4, wherein the fruit or vegetable is provided at a bottom portion of the countercurrent exchange device and wherein the first or second deacidified juice, or both, is fed at the top of the countercurrent exchange device.

19. The method of claim 1, wherein the fruit or vegetable in the optimizer is a fruit, and the fruit is a cranberry, grape, blueberry, raspberry, elderberry, lingonberry, chokeberry, blackberry, blackcurrant, redcurrant, white currant, huckleberry, cloudberry, or strawberry.

20. The method of claim 1, wherein fruit or vegetable in the optimizer comprises at least two different types of fruit.

21. The method of claim 20, wherein the at least two different types of fruit are selected from the group consisting of cranberry, grape, blueberry, raspberry, elderberry, lingonberry, chokeberry, blackberry, blackcurrant, redcurrant, white currant, huckleberry, cloudberry, and strawberry.

22. The method of claim 1, wherein the bulking agent comprises at least one of glucose, fructose, maltodextrin, inulin, soluble fiber, or protein.

23. The method of claim 1, wherein the bulking agent is derived from the same type of fruit or vegetable as that present in the optimizer.

24. The method of claim 1, further comprising removing the infused fruit or vegetable product from the optimizer and drying the infused fruit or vegetable product.

25. A dried fruit or vegetable product produced by the method of any one of claims 1-24.

26. A system comprising:
an optimizer configured to cause an exchange of acids and/or sugars between a fruit or vegetable and an extraction/infusion liquid;
an ultrafiltration device in fluid communication with the optimizer and configured to remove proanthocyanidins and phenolics from a liquid;
a deacidification subsystem in fluid communication with the ultrafiltration device and configured to remove acids from a liquid; and
a mixing subsystem in fluid communication with both the deacidification subsystem and the optimizer, and configured to mix a deacidified juice and a bulking agent.

27. The system of claim 26, wherein the optimizer is a countercurrent exchange device.

28. The system of claim 26, wherein the optimizer includes a device for scarifying, pricking, slicing, or pitting the fruit or vegetable.

29. The system of claim 26, wherein the optimizer is a module including two or more single- or multi-functional separate devices, each device being connected by lines.

30. The system of claim 26, wherein the optimizer includes a tank, a countercurrrent infusion device, a countercurrent extraction device, or any combination thereof.

31. The system of claim 26, wherein the optimizer comprises multiple modules.

32. The system of claim 26, wherein the deacidification subsystem comprises a bed of a first anion exchange resin configured to remove malic and citric acids from a liquid and a bed of a second anion-exchange resin configured to remove quinic acid from a liquid.

33. The system of claim 26, wherein the deacidification subsystem comprises a bipolar electrodialysis unit.

34. The system of claim 26, wherein the mixing subsystem comprises at least one blend tank and at least one hold tank.

35. A method, comprising:
contacting a fruit or vegetable with a first deacidified juice comprising a sugar concentration at least about equal to that in the fruit or vegetable, under conditions that allow concurrent removal of acids from the fruit or vegetable and of maintenance or increasing the sugar level in the fruit or vegetable, to thereby produce an acidified juice and a reduced-acid fruit or vegetable product.

36. The method of claim 35, further comprising removing acids from the acidified juice to produce a second deacidified juice.

37. The method of claim 36, wherein removing acids from the acidified juice comprises removing malic and citric acids in a first anion exchange process and removing quinic acid in a second anion exchange process.

38. The method of claim 35, wherein the fruit or vegetable is a fruit, and fruit is a cranberry.

39. The method of claim 35, wherein the acidified juice further comprises proanthocyanidins and phenolics removed from the fruit.

40. The method of claim 39, further comprising removing proanthocyanidins and phenolics from the acidified juice via ultrafiltration.

41. The method of claim 35, wherein the first deacidified juice comprises at least one bulking agent selected from the group consisting of glucose, fructose, maltodextrin, inulin, and soluble fiber.

42. The method of claim 35, wherein the first deacidified juice is derived from the same type of fruit or vegetable as that being contacted with the first deacidified juice.

43. The method of claim 35, wherein the first deacidified juice is derived from cranberries.

44. The method of claim 35, wherein contacting comprises contacting using countercurrent exchange.

45. The method of claim 44, wherein the fruit or vegetable is provided at a bottom portion of a countercurrent exchange device and wherein the deacidified juice is fed at a top of the countercurrent exchange device.

46. The method of claim 35, wherein the fruit or vegetable is a fruit, and the fruit is a cranberry, grape, blueberry, raspberry, elderberry, lingonberry, chokeberry, blackberry, blackcurrant, redcurrant, white currant, huckleberry, cloudberry, or strawberry.

47. The method of claim 35, wherein fruit or vegetable comprises at least two different types of fruit.

48. The method of claim 47, wherein the at least two different types of fruit are selected from the group consisting of cranberry, grape, blueberry, raspberry, elderberry, lingonberry, chokeberry, blackberry, blackcurrant, redcurrant, white currant, huckleberry, cloudberry, and strawberry.

49. The method of claim 35, wherein the concentrations of fructose and glucose in the first deacidified juice is greater than or equal to the concentrations of fructose and glucose in the fruit or vegetable.

50. The method of claim 35, wherein the dissolved solids content of the acidified juice is approximately 1% to 65% wt.

51. The method of claim 35, wherein the first deacidified juice has a pH of approximately 3.5 to 6.0.

52. A method of purifying an acid from a fruit juice, the method comprising:
contacting the fruit juice with a first anion exchange resin, wherein the first anion exchange resin is configured to adsorb malic acid and citric acid from the fruit juice, thereby producing a partially deacidified fruit juice;
contacting the partially deacidified fruit juice with a second anion exchange resin, wherein the second anion exchange resin is configured to adsorb quinic acid from the partially deacidified fruit juice, thereby producing a deacidified fruit juice and quinic acid adsorbed to the second anion exchange resin;
eluting, from the second anion exchange resin, a quinic acid rich solution comprising quinic acid and salts; and
contacting the quinic acid rich solution with a strong acid cation exchange resin, thereby separating the quinic acid rich solution into an acid solution and a salt solution.

53. The method of claim 52, further comprising crystallizing the quinic acid.

54. The method of claim 52, wherein crystallizing the quinic acid comprises concentrating the quinic acid solution under vacuum to a concentration of greater than 45% m/m, seeding the solution with 1% dry weight basis of purified quinic acid, and cooling the solution to 1° C.

55. The method of claim 52, wherein at least one of the first anion exchange resin, the second anion exchange resin, and the strong acid cation exchange resin, is disposed in a bed.

56. The method of claim 52, wherein the fruit juice is cranberry juice.

57. The method of claim 52, wherein the fruit juice has a dissolved solids content of about 1% to about 70% wt.

58. The method of claim 57, wherein the fruit juice has a dissolved solids content of about 1% to about 25% wt.

59. The method of claim 58, wherein the fruit juice has a dissolved solids content of about 16% to about 20% wt.

60. The method of claim 52, wherein the at least one of the first anion exchange resin and the second anion exchange resin is a macroporous polystyrene based resin comprising divinyl benzene co-polymers.

61. The method of claim 52, wherein eluting the quinic acid comprises rinsing the second anion exchange resin with a minimum 0.253 N basic solution.

62. The method of claim 52, further comprising regenerating the strong acid cation exchange resin with hydrochloric acid.

63. A method of deacidifying a fruit juice, the method comprising:
contacting the fruit juice with a first anion exchange resin configured to adsorb malic acid and citric acid from the fruit juice, thereby producing a partially deacidified fruit juice; and
contacting the partially deacidified fruit juice with a second anion exchange resin configured to adsorb quinic acid from the partially deacidifed fruit juice to thereby produce a deacidified fruit juice, wherein the second anion exchange resin has a higher affinity for quinic acid than the first anion exchange resin.

64. The method of claim 63, wherein the fruit juice is cranberry juice.

65. The method of claim 63, further comprising measuring at least one of acid content and pH based on a color of cranberry pigment.

66. The method of claim 63, wherein the fruit juice has a dissolved solids content of about 1% to about 70% wt.

67. The method of claim 66, wherein the fruit juice has a dissolved solids content of about 1% to about 25% wt.

68. The method of claim 67, wherein the fruit juice has a dissolved solids content of about 16% to about 20% wt.

69. The method of claim 63, further comprising eluting the malic acid and citric acid from the first anion exchange resin with a basic solution at a concentration of 0.1 to 1.0 N.

70. The method of claim 63, further comprising regenerating the first anion exchange resin with a maximum 1.04 N basic solution.

71. A deacidified fruit juice produced by the method of any of claims 63-70.

72. A method of producing an alcoholic beverage, the method comprising:
contacting a fruit juice with a first anion exchange resin configured to adsorb malic acid and citric acid from the fruit juice, thereby producing a partially deacidified fruit juice;
contacting the partially deacidified fruit juice with a second anion exchange resin configured to remove quinic acid from the partially deacidified fruit juice to thereby produce a deacidified fruit juice, wherein the second anion exchange resin has a higher affinity for quinic acid than the first anion exchange resin; and
fermenting the deacidified fruit juice.

73. The method of claim 72, further comprising mixing, prior to fermenting, a volume of non-deacidified fruit juice with the deacidified fruit juice.

74. The method of claim 73, wherein mixing produces a fruit juice having a pH between 3.5 and 6.0.

75. The method of claim 72, wherein the fruit juice is cranberry juice.

76. The method of claim 72, wherein the fruit juice has a dissolved solids content of about 1% to about 65% wt.

77. The method of claim 76, wherein the fruit juice has a dissolved solids content of about 1% to about 25% wt.

78. The method of claim 78, wherein the fruit juice has a dissolved solids content of about 16% to about 20% wt.

79. An alcoholic beverage produced by the method of any of claims 72-78.

80. A method of producing an alcoholic beverage, the method comprising:
contacting a fruit juice with a first anion exchange resin configured to adsorb malic acid and citric acid from the fruit juice to thereby produce a partially deacidified fruit juice; and
fermenting the partially deacidified fruit juice.

81. The method of claim 80, wherein the partially deacidified fruit juice has a pH between 3.5 and 6.0.

82. A method, comprising:
forming a mixture of water and cellulosic biomass material derived from fruit, the cellulosic biomass material comprising insoluble solids;
raising the temperature of the mixture to greater than or equal to 150° C. and the pressure of the mixture to greater than or equal to 50 psi, thereby converting insoluble solids in the cellulosic biomass material to soluble solids; and
separating the soluble solids and water from remaining insoluble solids.

83. The method of claim 82, wherein separating soluble solids comprises separating the soluble solids from the remaining insoluble solids via centrifugation.

84. The method of claim 82, wherein separating the soluble solids comprises separating the soluble solids from the remaining insoluble solids via filtration.

85. The method of claim 82, wherein separating the soluble solids comprises separating the soluble solids from the remaining insoluble solids via a combination of centrifugation and filtration.

86. The method of claim 82, wherein the temperature is raised to approximately 150-200° C. and the pressure is raised to approximately 500-2500 psi.

87. The method of claim 82, wherein the temperature is raised to approximately 150-200° C. and the pressure is raised to approximately 50-500 psi.

88. The method of claim 82, further comprising pre-heating the mixture to approximately 50° C. to 99° C.

89. The method of claim 82, wherein soluble solids separated from the remaining insoluble solids comprise at least a 40% yield of soluble solids from the cellulosic biomass material.

90. The method of claim 82 wherein the soluble solids separated from the remaining insoluble solids comprise at least a 60% yield of soluble solids from the cellulosic biomass material.

91. The method of claim 82, further comprising washing the remaining insoluble solids to capture soluble solids trapped among the remaining insoluble solids.

92. The method of claim 82, wherein the cellulosic biomass material is presscake, pomace, or whole fruit.

93. The method of claim 92, wherein the presscake, pomace, or whole fruit is derived from or comprises cranberries.

94. The method of claim 82, further comprising converting at least some of the soluble solids into at least one of sugars, alcohols, and small chain fatty acids, or any combination thereof.

95. The method of claim 94, wherein converting at least some of the soluble solids into sugars comprises digesting the soluble solids with enzymes.

96. The method of claim 82, wherein the method is performed as a batch process with a pressure cooker, an autoclave, or a subcritical water extraction unit, or any combination thereof.

97. The method of claim 82, wherein the mixture is heated under pressure for approximately 3 to 10 minutes.

98. The method of claim 82, further comprising cooling the mixture to a temperature of approximately 4° C. to 50° C.

99. A method of converting insoluble solids to soluble solids, comprising:
forming a mixture of water and cellulosic biomass material derived from fruit, the cellulosic biomass material comprising insoluble solids;
passing the mixture of water and cellulosic biomass material through a direct steam injection system with a steam pressure of at least approximately 125 psig and that heats the mixture to at least 150° C. with a back pressure of at least 55 psig; and
separating the soluble solids and water from remaining insoluble solids.

100. The method of claim 99, wherein separating soluble solids comprises separating the soluble solids from the remaining insoluble solids via centrifugation.

101. The method of claim 99, wherein separating the soluble solids comprises separating the soluble solids from the remaining insoluble solids via filtration.

102. The method of claim 99, wherein separating the soluble solids comprises separating the soluble solids from the remaining insoluble solids via a combination of centrifugation and filtration.

103. The method of claim 99, further comprising pre-heating the mixture to approximately 50° C. to 99° C.

104. The method of claim 99, wherein soluble solids separated from the remaining insoluble solids comprise at least a 40% yield of soluble solids from the cellulosic biomass material.

105. The method of claim 99, wherein the soluble solids separated from the remaining insoluble solids comprise at least a 60% yield of soluble solids from the cellulosic biomass material.

106. The method of claim 99, further comprising washing the remaining insoluble solids to capture soluble solids trapped among the remaining insoluble solids.

107. The method of claim 99, wherein the cellulosic biomass material is presscake, pomace, or whole fruit.

108. The method of claim 107, wherein the presscake, pomace, or whole fruit is derived from or comprises cranberries.

109. The method of claim 99, further comprising converting at least some of the soluble solids into at least one of sugars, alcohols, and small chain fatty acids, or any combination thereof.

110. The method of claim 109, wherein converting at least some of the soluble solids into sugars comprises digesting the soluble solids with enzymes.

111. A method of treating a food body, the method comprising:
introducing the food body to a tank, the food body being suspended in a liquid medium and having a first temperature;
introducing additional liquid medium to the tank, the additional liquid medium having a second temperature;
mixing the liquid medium and the additional liquid medium in the tank at a low shear rate; and
removing the food body from the tank, wherein the food body has a third temperature upon removal,
wherein the first temperature is lower than the third temperature and the third temperature is lower than the second temperature, and wherein the third temperature is in the range of about 35° F. to about 70° F.

112. The method of claim 111, wherein the first temperature is in the range of about 10° F. to about 32° F.

113. The method of claim 111, wherein the second temperature is in the range of about 60° F. to 120° F.

114. The method of claim 111, wherein the food body has a residence time in the tank of approximately 2 minutes to 30 minutes.

115. The method of claim 111, wherein the tank comprises an impeller disposed on a shaft.

116. The method of claim 111, wherein the tank has an approximately circular footprint and the shaft and the impeller are located off-center of the center of the approximately circular footprint.

117. The method of claim 116, wherein mixing the liquid medium and the additional liquid medium at a low shear rate comprises vertically circulating the liquid medium and the additional liquid medium in the tank.

118. The method of claim 117, wherein the impeller has two inner lobes, each inner lobe connected on an opposite side of the shaft, and two outer lobes, each outer lobe connected to an inner lobe, wherein the inner lobes circulate the liquid medium in a first vertical direction and the outer lobes circulate the liquid medium in a second vertical direction.

119. The method of claim 111, wherein the food body is in a frozen state when the food body is at the first temperature and wherein the food body is in an unfrozen state at the third temperature.

120. A system comprising:
a tank, comprising:
a shaft disposed in the tank and extending from the bottom of the tank to the top of the tank, the shaft being configured to rotate; and
a first impeller positioned on the shaft and configured to rotate with the shaft, the impeller having a shape configured to vertically circulate liquid media in the tank;
a first inlet configured to deliver a food body suspended in liquid media at a first temperature to a tank;
a second inlet configured to deliver additional liquid media at a second temperature to the tank; and
an outlet configured to deliver a food body suspended in liquid media at a third temperature from the tank,
wherein the first temperature is lower than the third temperature and the third temperature is lower than the second temperature,
wherein the third temperature is in a range of about 35° F. to about 70° F.

121. The system of claim 120, wherein the first temperature is approximately 10° F. to 32° F.

122. The system of claim 120, wherein the second temperature is approximately 60° F. to 120° F.

123. The system of claim 120, wherein the food body has a residence time in the tank of approximately 2 minutes to 30 minutes.

124. The system of claim 120, further comprising a separator connected to the outlet and configured to separate the food body from the liquid media at the third temperature.

125. The system of claim 124, further comprising a heating element configured to heat the liquid media from the third temperature to the second temperature and further comprising a return configured to return the liquid media heated to the second temperature to the second inlet.

126. The system of claim 124, wherein the tank has an approximately circular footprint and the shaft and the first impeller are located off-center of the center of the approximately circular footprint.

127. The system of claim 124, wherein the separator is a shaker.

128. The system of claim 120, wherein the wherein the first impeller has two inner lobes, each inner lobe connected on an opposite side of the shaft, and two outer lobes, each outer lobe connected to an inner lobe, wherein the inner lobes circulate the liquid medium in a first vertical direction and the outer lobes circulate the liquid medium in a second vertical direction.

129. The system of claim 128, wherein the inner lobes of the first impeller have greater surface area than the outer lobes of the impeller.

130. The system of claim 128, wherein the outer lobes of the first impeller are angularly offset from the inner lobes of the impeller.

131. The system of claim 120, wherein the food body is in a frozen state when the food body is at the first temperature and wherein the food body is in an unfrozen state at the third temperature.

132. The system of claim 120, further comprising a second impeller disposed on the shaft.

133. The system of claim 132, wherein the first impeller is positioned lower on the shaft than the second impeller.

134. An infused fruit or vegetable having a ratio of total acids to phenolics of less than 4:1.

135. The infused fruit or vegetable of claim 134, further comprising an infused bulking agent comprising at least one of glucose, fructose, sucrose, a sugar alcohol, maltodextrin, a dextrin, a glucan, a fructan, soluble fibers, amino acids, peptides, and partially hydrolyzed proteins of less than 10,000 Daltons.

136. The infused fruit or vegetable of claim 134, wherein the infused fruit or vegetable is an infused cranberry.

137. The infused cranberry of claim 136, further comprising glucose at approximately 4% by weight and fructose at approximately 1% by weight.

138. The infused cranberry of claim 136, further comprising a ratio of quinic acid to citric acid to malic acid between 1.0:1.0:0.8 and 10.0:1.0:2.0.

139. The infused cranberry of claim 136, further comprising nonpolar molecules having a carbon to oxygen ratio ranging from 18:2 to 28:2.

140. A composition comprising the infused fruit or vegetable of claim 134.
